(19) United States
(12) Patent Application Publication
(10) Pub. No.: US 2009/0144153 A1
(43) Pub. Date: Jun. 4, 2009

(54) Techniques for acquiring a set of digital media assets

(76) Inventors: Roberth H. Kondrk, Los Angeles, CA (US); Alexandrea Anderson, Clovis, CA (US); Dobbie Shimizu, San Jose, CA (US); Elizabeth d'Errico, Redwood City, CA (US); Patrice Gautier, San Francisco, CA (US); Payam Mirrashidi, San Francisco, CA (US); Catherine Wormington, San Carlos, CA (US); Monika Gromek, Oakland, CA (US); Ellis Verosub, San Carlos, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/322,339

(22) Filed: Jan. 30, 2009

Related U.S. Application Data
(63) Continuation-in-part of application No. 11/370,347, filed on Mar. 7, 2006.
Application No. 11/370,347 is a continuation-in-part of application No. 11/247,948, filed on Oct. 10, 2005.
Application No. 11/247,948 is a continuation-in-part of application No. 11/212,314, filed on Aug. 24, 2005.
(60) Provisional application No. 60/675,731, filed on Apr. 27, 2005.

(51) Int. Cl. G06Q 30/00; G06Q 50/00; G06F 15/16; G06Q 20/00

(52) U.S. Cl. 705/14; 707/103 R; 705/26; 709/206

(57) ABSTRACT

Techniques to facilitate acquiring a media set, or a related series, of digital media assets from an on-line media store are disclosed. A user can view various media sets that have been listed as available for purchase from the on-line media store. A user can choose to purchase a particular media set even though some or all digital media assets to be included in the particular media set are not yet available. Subsequent to the purchase of the particular media set, the digital media assets of the particular media set can be delivered to the user once the digital media assets become available. Since the monitoring is computerized and the delivery is electronic, once digital media assets becomes available, delivery can be automatically processed.

### CROSS-REFERENCE TO RELATED APPLICATIONS

This application is a continuation-in-part of U.S. patent application Ser. No. 11/370,347, filed Mar. 7, 2006, and entitled “TECHNIQUES FOR ACQUIRING A MEDIA SEASON OF DIGITAL MEDIA ASSETS,” which is hereby incorporated herein by reference, which is a continuation-in-part of U.S. patent application Ser. No. 11/247,948, filed Oct. 10, 2005, and entitled “ON-LINE MEDIA STORE THAT SUPPORTS PRE-ORDERING OF DIGITAL MEDIA ASSETS,” which is hereby incorporated herein by reference, which is a continuation-in-part of U.S. patent application Ser. No. 11/212,314, filed Aug. 24, 2005, and entitled “ON-LINE MEDIA STORE THAT SUPPORTS PRE-ORDERING OF DIGITAL MEDIA ASSETS,” which is hereby incorporated herein by reference, and which claims priority to U.S. Provisional Patent Application No. 60/675,731, filed Apr. 27, 2005, and entitled “ON-LINE MEDIA STORE THAT SUPPORTS PRE-ORDERING OF DIGITAL MEDIA ASSETS,” which is hereby incorporated herein by reference.

This application also claims priority to U.S. Provisional Patent Application No. 61/117,882, filed Nov. 25, 2008, and entitled “TECHNIQUES FOR ACQUIRING A SET OF DIGITAL MEDIA ASSETS,” which is hereby incorporated herein by reference.

U.S. patent application Ser. No. 11/370,347 also claims priority to U.S. Provisional Patent Application No. 60/675,731, filed Apr. 27, 2005, and entitled “ON-LINE MEDIA STORE THAT SUPPORTS PRE-ORDERING OF DIGITAL MEDIA ASSETS,” which is hereby incorporated herein by reference.

This application is also related to: (i) U.S. patent application Ser. No. 10/833,267, filed Apr. 26, 2004, and entitled “METHOD AND SYSTEM FOR NETWORK-BASED PURCHASE AND DISTRIBUTION OF MEDIA,” which is hereby incorporated herein by reference; and (ii) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION,” which is hereby incorporated herein by reference.

### BACKGROUND OF THE INVENTION

1. Field of the Invention

The present invention relates to digital media assets and, more particularly, to network-based acquisition of sets of digital media assets.

2. Description of the Related Art

Television shows are recorded and then scheduled for broadcast to viewers over cable or airwaves. Often the television shows are daily or weekly programs. As such, in a given season of television shows, many shows will provide a number of different episodes that are broadcast over the course of the season. Users can receive and view the shows at the specific times of their broadcast. However, after the episodes have been broadcasted, the episodes are not readily available, unless a user has recorded the broadcast onto a tape (e.g., VHS tape), DVD or data storage drive (e.g., TIVO). Occasionally, a previously broadcasted episode of a show will be re-broadcast (known as a “re-run”). After a season is over, a media company owning rights in a television show may package the various episodes of a show onto a DVD and offer the DVD for sale at retail stores. For example, an entire season of episodes of a particular television show can be provided on a DVD and sold.

Recently, videos have become available for download from media servers located on the Internet. Unfortunately, when a video pertains to a television show that has a season of episodes, the user has to access, locate and download each of the episodes for the show. This is time consuming and burdensome on the user, particularly since the episodes are released over the course of the season. Thus, there is a need for improved approaches to acquiring a season of shows from an on-line media source.

Also, in the case of music, users can access on-line media sources to access, locate and download music files. For example, at the iTunes® music store users can browse, purchase and download singles or albums from various different artists or groups. However, there remains a need to provide improved approaches to acquire music from an on-line media source.

### SUMMARY OF THE INVENTION

The invention pertains to acquiring a media set, or a related series, of digital media assets. The digital media assets are electronically delivered, such as from an on-line media store. A user can view various media sets that have been listed as available for purchase from the on-line media store. A user can choose to purchase a particular media set. Subsequent to the purchase of the particular media season, digital media assets of the particular media set can be delivered to the user once the digital media assets become available. Since the monitoring is computerized and the delivery is electronic, once a digital media asset becomes available, delivery can be automatically processed.

According to one aspect, in certain embodiments of the invention, a season, or related series, of digital media assets can be purchased as a set. Often, the set can be purchased at a lower price than would be charged if the digital media assets were individually purchased. Typically, none or some but not all of the digital media assets of the set are available at the time of purchase. Consequently, as the digital media assets become available, they are associated with the set and can be delivered to the user. In one embodiment, the digital media assets of a particular media season, or related season, are episodes of a show, such as a television show or event. A user can view various media seasons that have been listed as available for purchase from the on-line media store. The episodes, in one example, are audiovisual media content, such as video content.

According to another aspect, in certain embodiments of the invention, sets of digital media assets can be made available. Each of the sets of digital media assets can pertain to a particular artist, group, developer, label, producer, ranking, popularity, event, series, season, etc. Each of the sets of digital media assets can include one or more different types of digital media assets. Through use of an on-line media store, users can purchase sets of digital media assets. However, at the time of purchase, the specific digital media assets included within the sets of the related digital media assets can be partially or completely unknown. However, in one embodiment, the number of digital media assets to be included in a set of digital media assets can be known or estimated. The different types of digital media assets within a set (e.g., media set) can, for example, include one or more of songs, albums, videos (e.g., music videos, bonus videos, etc.), podcasts, or audiobooks.

The invention can be implemented in numerous ways, including as a method, system, device, apparatus (including graphical user interface or computer readable medium). Several embodiments of the invention are discussed below.

As a method for acquiring a set of digital media assets from an on-line media store, one embodiment of the invention can, for example, include at least: presenting a plurality of sets of related digital media assets that are available for purchase on the on-line media store, for each of the set of related digital media assets available for purchase, at least a portion of the digital media assets to be included therein are unavailable from the on-line media store; receiving a selection of one of the sets of related digital media assets to be purchased; initiating purchase of the selected one of the sets of related digital media assets; and permitting delivery of available ones of the digital media assets of the selected one of the sets of related digital media assets.

As a method for acquiring digital media assets from an online repository, one embodiment of the invention can, for example, include at least: facilitating browsing of sets of digital media assets available for browsing and purchasing from an online repository, where the sets are defined by set characteristics, and where the sets of digital media assets are available even though at least one of the digital media assets for each of the sets of digital media assets does not yet exist; processing purchase of a selected set of digital media assets; delivering those of the digital media assets of the selected set of digital media assets that are available; subsequently determining whether one or more newly available digital media assets exist for the selected set of digital media assets; delivering the one or more newly available digital media assets for the selected set of digital media assets that are determined to exist; determining whether the set of digital media assets is completed; and denoting the set of digital media assets as completed if it is determined that the set of digital media assets is completed.

As a computer readable medium including at least executable computer program code stored therein for acquiring a set of digital media assets from an on-line media store, one embodiment of the invention can, for example, include at least: computer program code for presenting a plurality of media sets that are available for purchase on the on-line media store; computer program code for receiving a selection of one of the media sets to be purchased; computer program code for initiating purchase of the selected media set; and computer program code for permitting delivery of available ones of the digital media assets of the selected media set.

As a media server, one embodiment of the invention can, for example,

include at least: a data storage device suitable for storing (i) media set information for a plurality of sets of digital media assets, with the media set information for each of the sets of digital media assets characterizing a plurality of digital media assets that are included within such set, and (ii) at least a subset of the plurality of digital media assets or pointers thereto; and a data processing unit operatively connected to the data storage device. The data processing unit being configured to perform a purchase process to enable users to select one or more of the sets of digital media assets for purchase. The processing unit being further configured to perform a fulfillment process to deliver, to the user that has purchased such, a first portion of the plurality of digital media assets that are currently available for the purchased set of digital media assets and one or more remaining portions of the digital media assets as they become available.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The invention will be readily understood by the following detailed description in conjunction with the accompanying drawings, wherein like reference numerals designate like structural elements, and in which:

FIG. 1 is a block diagram of a media purchase system according to one embodiment of the invention.

FIG. 2A is a diagram of a media season management system according to one embodiment of the invention.

FIG. 2B is a flow diagram of a media series acquisition process according to one embodiment of the invention.

FIG. 3A is a flow diagram of a season purchase request process according to one embodiment of the invention.

FIG. 3B is a flow diagram of a season purchase process according to one embodiment of the invention.

FIG. 3C is a diagram of a representative media season window according to one embodiment of the invention.

FIG. 3D is a representative season purchase confirmation window according to one embodiment of the invention.

FIG. 4 is a flow diagram of an episode notification process according to one embodiment of the invention.

FIG. 5 is a flow diagram of an episode delivery process according to one embodiment of the invention.

FIG. 6 is a flow diagram of a season cancellation process according to one embodiment of the invention.

FIG. 7 is a representative season status window according to one embodiment of the invention.

FIG. 8A is a diagram of a media set management system according to one embodiment of the invention.

FIG. 8B is a flow diagram of a media set acquisition process according to one embodiment of the invention.

FIG. 9A is a flow diagram of a media set purchase request process according to one embodiment of the invention.

FIG. 9B is a flow diagram of a media set purchase process according to one embodiment of the invention.

FIG. 10 is a flow diagram of an asset notification process according to one embodiment of the invention.

FIG. 11 is a flow diagram of an asset delivery process according to one embodiment of the invention.

FIG. 12 is a flow diagram of a media set cancellation process according to one embodiment of the invention.

FIG. 13 is a flow diagram of a media pass availability process according to one embodiment of the invention.

FIGS. 14A and 14B are flow diagrams of media pass acquisition process according to one embodiment of the invention.

FIG. 15 shows an exemplary computer system suitable for use with the invention.

FIGS. 16-38 are screen illustrations associated with one or more embodiments of the invention.

### DETAILED DESCRIPTION OF THE INVENTION

The invention pertains to acquiring a media set, or a related series, of digital media assets. The digital media assets are electronically delivered, such as from an on-line media store. A user can view various media sets that have been listed as available for purchase from the on-line media store. A user can choose to purchase a particular media set. Subsequent to the purchase of the particular media season, digital media assets of the particular media set can be delivered to the user once the digital media assets become available. Since the monitoring is computerized and the delivery is electronic, once a digital media asset becomes available, delivery can be automatically processed.

According to one aspect, in certain embodiments of the invention, a season, or related series, of digital media assets can be purchased as a set. Often, the set can be purchased at a lower price than would be charged if the digital media assets were individually purchased. Typically, none or some but not all of the digital media assets of the set are available at the time of purchase. Consequently, as the digital media assets become available, they are associated with the set and can be delivered to the user. In one embodiment, the digital media assets of a particular media season, or related season, are episodes of a show, such as a television show or event. A user can view various media seasons that have been listed as available for purchase from the on-line media store. The episodes, in one example, are audiovisual media content, such as video content.

According to another aspect, in certain embodiments of the invention, sets of digital media assets can be made available. Each of the sets of digital media assets can pertain to a particular artist, group, developer, label, producer, ranking, popularity, event, series, season, etc. Each of the sets of digital media assets can include one or more different types of digital media assets. Through use of an on-line media store, users can purchase sets of digital media assets. However, at the time of purchase, the specific digital media assets included within the sets of the related digital media assets can be partially or completely unknown. However, in one embodiment, the number of digital media assets to be included in a set of digital media assets can be known or estimated. The different types of digital media assets within a set (e.g., media set) can, for example, include one or more of songs, albums, videos (e.g., music videos, bonus videos, etc.), podcasts, or audiobooks.

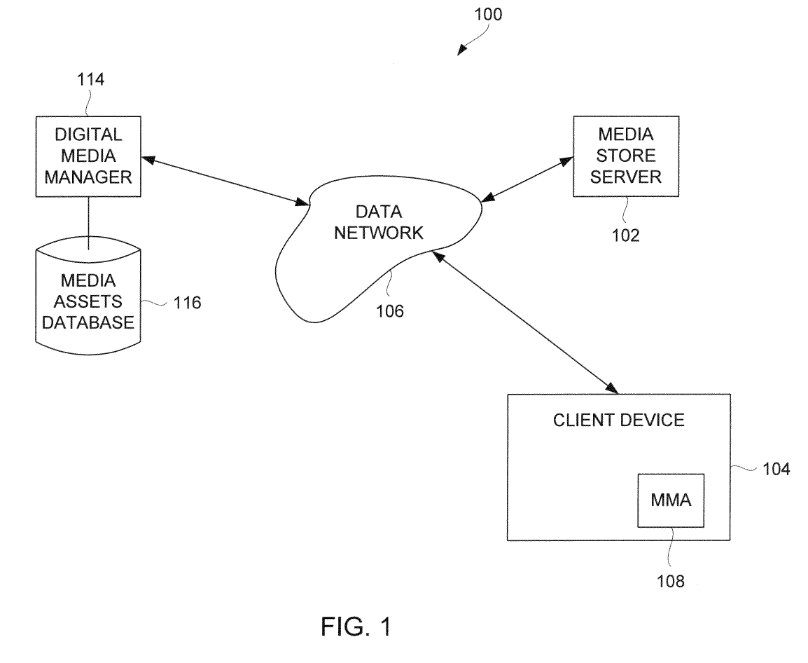

Embodiments of the invention are discussed below with reference to FIGS. 1-38. However, those skilled in the art will readily appreciate that the detailed description given herein with respect to these figures is for explanatory purposes as the invention extends beyond these limited embodiments.

FIG. 1 is a block diagram of a media purchase system 100 according to one embodiment of the invention. The media purchase system 100 includes a media store server 102 that hosts an on-line media store. The media store server 102 can off-load commerce transactions and/or delivery of purchased digital media assets to other servers, if desired. As shown in FIG. 1, the media purchase system 100 includes one or more client devices 104 for use by end users. The client devices 104 couple to a data network 106. Additionally, the media store server 102 also couples to the data network 106. In one implementation, the data network 106 can refer to one or more data networks, typically, high data-bandwidth networks, namely, wired networks, such as the Internet, Ethernet, gigabit Ethernet, and fiber optic, as well as wireless networks such as IEEE 802.11(a),(b) or (g) (WiFi), IEEE 802.16 (WiMax), and Ultra-Wide Band (UWB).

A computer program 108, typically a media management application (MMA) or other media player application, runs on the client device 104. One example of a media management application is the iTunes® application, produced by Apple Inc. of Cupertino, Calif. The client devices 104 are, in general, computing devices. As an example, the client devices 104 can be specific or general-purpose personal computers or portable media players. One example of a portable media player suitable for use with the invention is the iPod® media player, also produced by Apple Inc. The computer program 108 can be used by a consumer for a variety of purposes, including, but not limited to: (i) browsing and/or purchasing media assets (including sets, such as seasons, of media assets) from the on-line media store provided by the media store server 102, (ii) creating and sharing media asset groups (e.g., playlists), (iii) organizing media assets, (iv) presenting/playing media assets, and (v) transferring media assets between client devices 104.

The media purchase system 100 can also include a digital asset manager 114. The digital asset manager 114 is coupled to a media assets database 116. The media assets database 116 stores media asset information including metadata relating to digital media assets available for purchase at the on-line media store. In one embodiment, the digital asset manager 114 can control what media assets and media asset information are available on the on-line media store. The metadata can pertain to individual media assets (digital media assets) or media asset groups (digital media asset groups). One type of group of digital media assets is a season or a series of media assets. Another type of group of digital media assets is a set (e.g., media set) of digital media assets. Media assets can include, but are not limited to, audio, video and/or graphics files. However, a set of digital media assets can include one or more non-media assets (e.g., text) along with its digital media assets.

The media store server 102 enables the user of a particular client device 104 to purchase a set (e.g., season or series) of media assets (e.g., videos or songs) through on-line transactions. On-line transactions to purchase media items are also referred to as electronic commerce (e-commerce). Subsequently, the client device 104 can download the purchased media assets from the media store server 102, or some other server, via the data network 106. As will be understood by those familiar with data networks, other network configurations are possible. Furthermore, while the media store server 102 and the digital asset manager 114 are shown as individual and separate devices, it will be understood by those familiar with the art that other configurations are possible. As one example, each device can be implemented such that it is distributed over multiple server computers. As another example, these various servers and/or managers can be implemented by a single physical server computer.

According to a first aspect, the invention pertains to a system and method for acquiring a season of digital media assets over a network. A potential purchaser can search and browse through numerous seasons of digital media assets that are available for purchase. A potential purchaser can purchase a season of digital media assets, including numerous episodes, with a single transaction. Upon purchasing a season, as the digital media assets become available, they are made available to the purchaser. A season of digital media assets can correspond to a show or event. The digital media assets can also be referred to as episodes. Regardless, the digital media assets can pertain to audiovisual content, such as videos or movies.

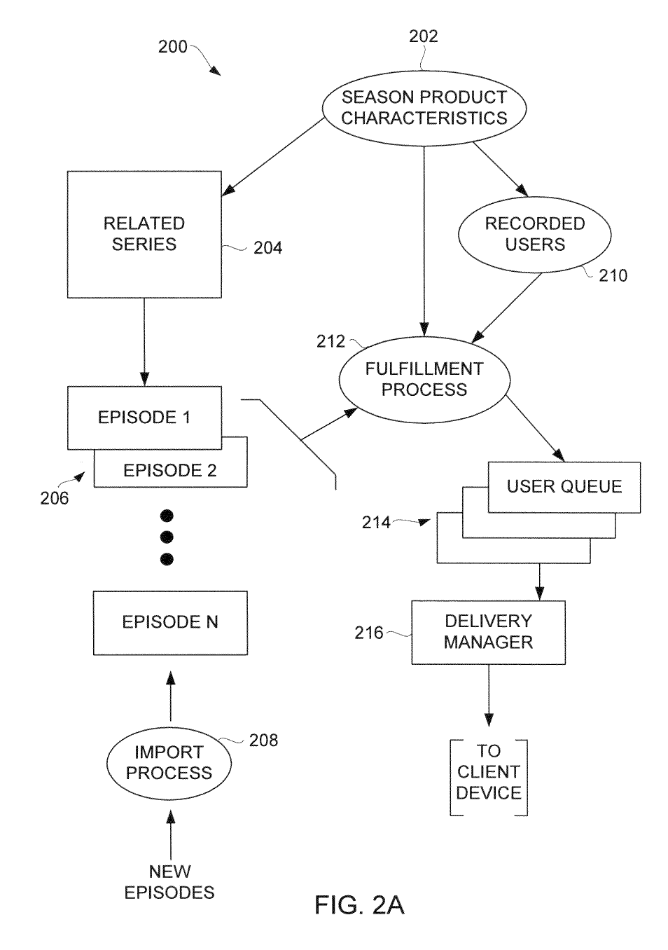

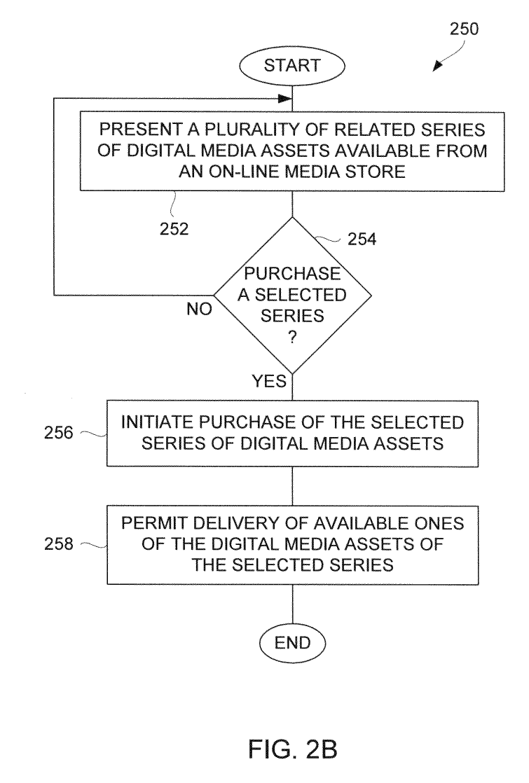

FIG. 2A is a diagram of a media season management system 200 according to one embodiment of the invention. The media season management system 200 can be provided by the media store server 102 illustrated in FIG. 1 or some other server associated therewith.

The media season management system 200 includes season product characteristics 202 for a plurality of media seasons. The season product characteristics 202 describe attributes of the media seasons which are made available and managed by the media season management system 200. For example, the attributes of a media season can include title, price, type, start and end dates, number of expected episodes, countries of distribution, etc. Each of the seasons has a related series of episodes associated therewith. For example, a particular media season has an associated related series 204. The related series 204 pertains to a group of episodes 206 that are associated with the particular media season. For example, the media season can pertain to a television show, and thus the related series 204 includes a plurality of episodes that pertain to the television show in the given media season. As another example, the media season can pertain to an event, such as a sporting event, and thus the related series 204 includes a plurality of episodes that pertain to the event in the given media season. Typically, the episodes of a series or media season are developed over the length of the season. For example, some related series have new episodes weekly, others have new episodes daily, etc. As these new episodes become available from content providers, the new episodes can be imported into the media season management system 200 by an import process 208. The import process 208 is automated such that the electronic delivery of new episodes can be automatically placed in the appropriate related series 204 as additional episodes 206 pertaining to a particular media season. To assist with the automatic import process 208, the new episodes contain metadata that describes certain characteristics of the new episodes. For example, the metadata can indicate the season or related series (i.e., title) and episode number for the new episode.

The media season management system 200 also maintains recorded users 210. The recorded users are those users that are recorded as having access to a season product. Typically, a user will become a recorded user when the user purchases access to a particular media season. The recorded users 210 are thus associated with the particular media season that they have permission to access. The recorded users 210 can also indicate one or more preferences they have regarding fulfillment of their access to the media seasons.

The media season management system 200 also includes a fulfillment process 212. The fulfillment process 212 operates to recognize the presence of new episodes 206 and then determines if there are any recorded users 210 that are to be notified about the presence of a new episode regarding a particular media season that they have permission to access. When the fulfillment process 212 determines that a particular user is to be provided with a new episode 206, then the fulfillment process 212 can provide the new episode 206 to a user queue 214 associated with the particular user.

The media season management system 200 also includes a delivery manager 216. The delivery manager 216 operates to assist with the delivery of the new episodes from the user queues 214 to the corresponding client devices. For example, the delivery manager 216 can electronically deliver (e.g., download) the new episodes from the appropriate user queue 214 to the corresponding client device when requested by a user or automatically upon accessing an on-line media store that incorporates or couples to the media season management system 200. In addition, in one embodiment, the fulfillment process 212 could initiate or provide an email notification to the particular user that the new episode is now available to be acquired (e.g., downloaded) by the particular user.

FIG. 2B is a flow diagram of a media series acquisition process 250 according to one embodiment of the invention. The media series acquisition process 250 can be associated with a media store server that provides or supports an on-line media store. For example, the media series acquisition process 250 can be associated with the media store server 102 illustrated in FIG. 1.

The media series acquisition process 250 initially presents 252 a plurality of related series of digital media assets available from an on-line media store. The related series of digital media assets can pertain to a media season, such as a media season for a particular show or event. For example, the media season can pertain to the 2005 media season for the television show “24”. As another example, the media season can pertain to the 2005 National Football League (NFL) season, namely, all games, highlights, or commentary. The presenting 252 of the plurality of related series is typically presented on a display device of a client device associated with a user. The user typically interacts with the client device so as to browse, search or otherwise navigate an on-line media store to review different available related series. At some point, the user can opt to purchase one of the plurality of related series that are being presented 252. Hence, a decision 254 determines whether a selected series is to be purchased. When the decision 254 determines that a selected series is not to be purchased, the media series acquisition process 250 can return to repeat the block 252 so that the user can continue to review the available related series. On the other hand, when the decision 254 determines that a related series is to be purchased, purchase of the selected series of digital media assets is initiated 256. The processing of the purchase can be performed immediately or can be deferred or can be partially performed. In one embodiment, the purchase price for the selected series of digital media assets is not completely charged or otherwise imposed on the purchaser at the time of initial purchase. Instead, the purchase price can be prorated over the episodes associated with the selected series. In any case, after the purchase of the selected series of digital media assets has been at least initiated 256, delivery of available ones of the digital media assets of the selected series can be permitted 258. When the delivery of the available ones of the digital media assets is permitted 258, the purchaser (user) is able to gain access to the available digital media assets. For example, the available digital media assets might immediately be downloaded to the client device associated with the purchaser, or the available digital media assets can be downloaded at a later point in time when more convenient for the purchaser. Following the block 258, the media series acquisition process 250 ends.

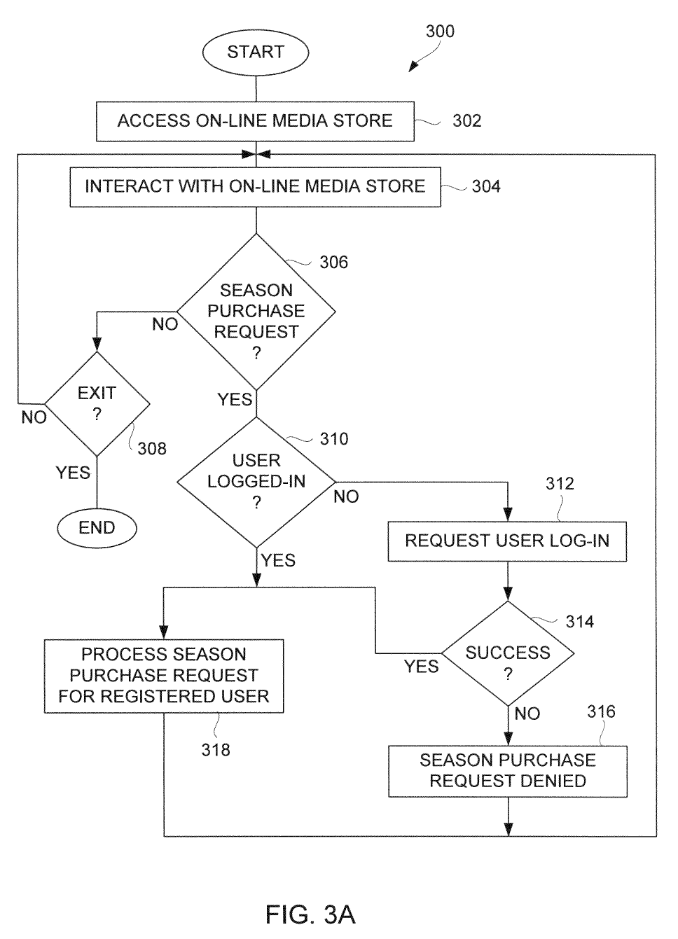

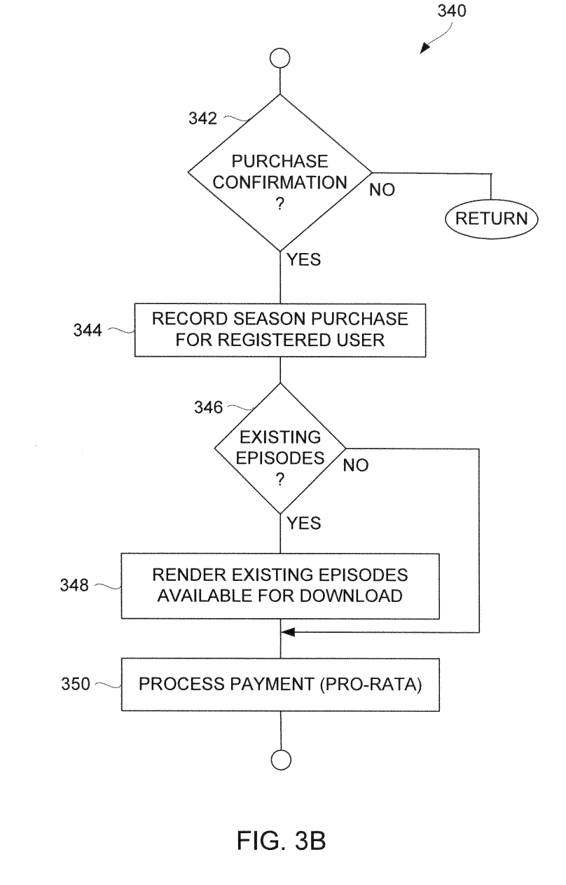

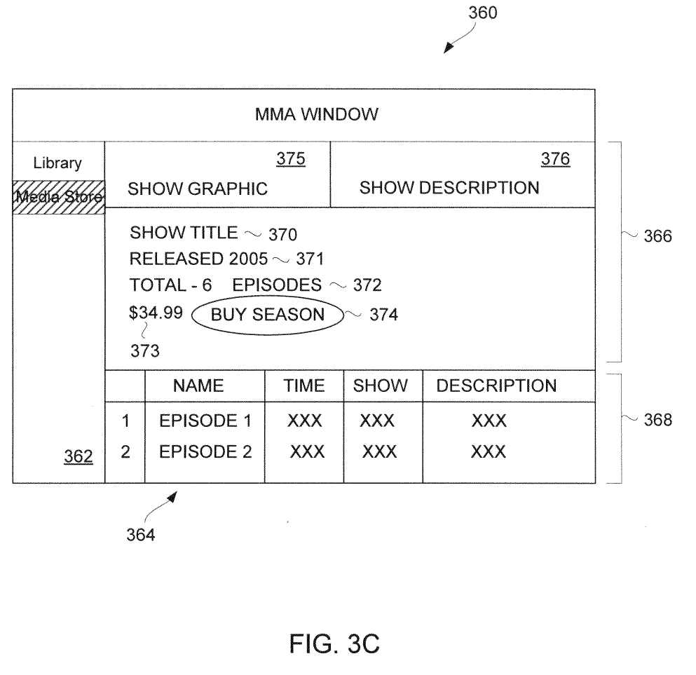

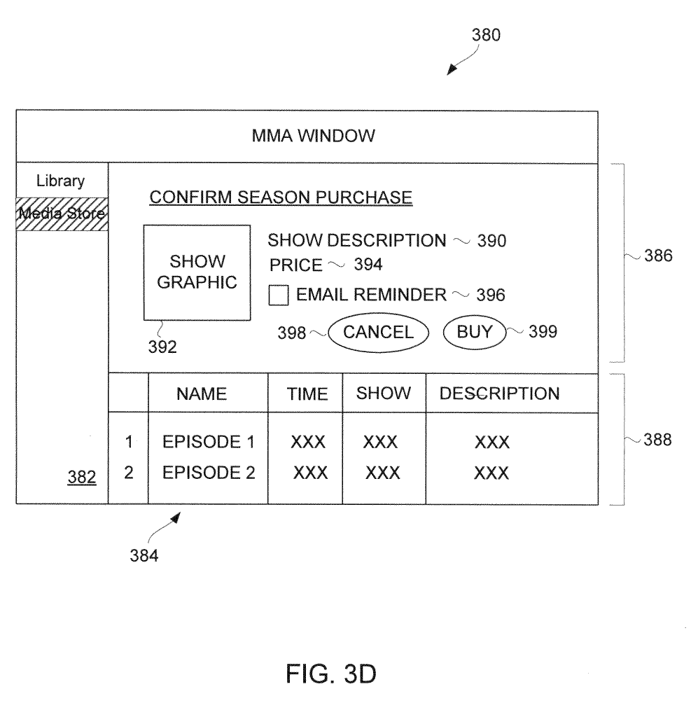

FIG. 3A is a flow diagram of a season purchase request process 300 according to one embodiment of the invention. The season purchase request process 300 begins with access 302 to an on-line media store. Typically, a user will access 302 the on-line media store via a data network, such as the Internet. Once the user has accessed 302 the on-line media store, the user can interact 304 with the on-line media store. The interaction 304 with the on-line media store can, for example, involve searching, browsing, displaying, previewing, purchasing, and/or organizing digital media assets. Although the season purchase request process 300 is primarily provided by a server, such as the media store server 102 illustrated in FIG. 1, the access 302 and the interaction 304 can be facilitated by a media management application operating on a client device, such as the client device 104 illustrated in FIG. 1.

Next, a decision 306 determines whether a season purchase request has been received. When the decision 306 determines that a season purchase request has not been received, a decision 308 determines whether the season purchase request process 300 should be exited. When the decision 308 determines that the season purchase request process 300 should not be exited, then the season purchase request process 300 returns to repeat the operation 304 and subsequent operations. Alternatively, when the decision 306 determines that the season purchase request process 300 should exit, then the season purchase request process 300 ends. In one embodiment, when media store content for a season is displayed by the on-line media store, a “season purchase” control (e.g., button) can be presented to the user. By selection of the “season purchase” control, the user can initiate a season purchase request.

On the other hand, when the decision 306 determines that a season purchase request has been received, then a decision 310 determines whether the user is logged-in to the on-line media store. When the decision 310 determines that the user is not currently logged-in to the on-line media store, a user login is requested 312. A decision 314 then determines whether the login has been successful. As an example, the user will submit login information, such as a user name and/or password, which is evaluated to determine whether the user is permitted to login. When the decision 314 determines that login was not successful, the season purchase request is denied 316. Alternatively, when the decision 310 determines that the user is already logged-in, or when the decision 314 determines that the user has just successfully logged-in, the season purchase for a particular season of digital media assets is processed 318 for the registered user. For example, the season purchase can be purchased such that it is associated with the registered user (e.g., associated with the user account for the registered user) so that the registered user is able to acquire the various digital media assets within the particular season that has been purchased. Following the operation 316 or 318, the season purchase request process 300 returns to repeat the operation 304 and subsequent operations so that additional interaction 304 with the on-line media store is permitted, including making additional season purchase requests if so desired.

FIG. 3B is a flow diagram of a season purchase process 340 according to one embodiment of the invention. The season purchase process 340 is, for example, processing suitable for being performed by the block 318 of the season purchase request process 300 illustrated in FIG. 3A.

The season purchase process 340 begins with a decision 342. The decision 342 determines whether the purchaser (user) has confirmed purchase of the particular season being purchased. The season can also be referred to as a media season. When the decision 342 determines that the user has not confirmed purchase of the media season, then the season purchase process 340 returns back to the block 304 illustrated in FIG. 3A, thereby undoing the previous season purchase request.

On the other hand, when the decision 342 determines that the user has confirmed purchase of the particular season, the season purchase for the registered user is recorded 344. For example, the season purchase can be recorded 344 in the recorded users 210 of the media season management system 200 illustrated in FIG. 2A.

After the season purchase for the registered user has been recorded 344, a decision 346 determines whether there are existing episodes for the media season that has been purchased. When the decision 346 determines that there are existing episodes, then the existing episodes are rendered 348 available for download. This permits the registered user to acquire the existing episodes at or soon after the time of purchase of the media season. Payment for the media season is also processed 350. Typically, the payment is processed such that only a portion of the total cost of the media season is initially imposed or charged to the registered user. In other words, the total cost for the media season can be pro-rated with respect to the percentage of existing episodes that are initially available as compared to the total number of episodes expected to be provided during the media season. Following the block 350, the season purchase process 340 ends and processing can return to block 304 of the season purchase request process 300 illustrated in FIG. 3A so that the user can continue to interact with the on-line media store for various operations, including again purchasing a media season.

Although the season purchase process 340 permits the registered user to acquire the existing episodes at or soon after the time of purchase of the media season, in some embodiments there are no prior episodes to be delivered. For example, if the media season has not yet started, there are no episodes.

A media season can include all episodes of a show or event corresponding to a particular media season. A media season can consist of a predetermined number of consecutive episodes of a show or event. For example, the media season being purchased can be defined as forward looking, meaning that only a current episode and future episodes are contained in the media season for the registered user. Consequently, different registered users can get a different set of episodes depending on when they purchase the media season. A media season can include episodes containing audiovisual content regarding highlights of one or more events, shows, or programs. For example, the media season can be audiovisual highlights for a particular sporting event.

FIG. 3C is a diagram of a representative media season window 360 according to one embodiment of the invention. The media season window 360 is typically presented on a display device associated with a client device when the client device is interacting with the on-line media store via a Media Management Application (MMA). More particularly, when the user is interacting with the on-line media store to view information pertaining to a media season (or season pass) that is available for purchase on the on-line media store. The media season window 360 includes a source portion 362 and a media season portion 364. The source portion 362 indicates the source for the information being presented in the media season portion 364. In this example, the source portion 362 indicates that a “Media Store” has been selected, such that the information being presented in the media season portion 364 is information provided by an on-line media store. In this case, the information corresponds to one of a plurality of media seasons that are available for purchase from the on-line media store. The media season portion 364 includes a media season information portion 366 and an episode listing area 368. The media season information portion 366 includes information pertaining to the media season, which in this implementation is referred to as a show. Hence, the media season information portion 366 includes a show title 370, a release date 371, total number of episodes 372 for the show, total cost 373 for the media season, and a “Buy Season” button 374. Upon selecting the “Buy Season” button 374, the user requests to purchase the particular media season. The media season information area 366 can also display a show graphic 375 and a show description 376 for the media season. The show graphic 375, for example, is a still graphic, animated graphics or video associated with the media season. The show description 376 details the specifics of the media season (e.g., show) being purchased, including how many episodes are to be provided.

The episode listing area 368 illustrates those of the episodes that are currently available for the associated media season being described in the media season information area 366. In this example, the episode listing area 368 indicates the presence of two episodes, namely, “Episode 1” and “Episode 2.” For each of the available episodes listed in the episode listing area, the name, time (duration), show and description for such episodes can be displayed in the episode listing area 368.

FIG. 3D is a representative season purchase confirmation window 380 according to one embodiment of the invention. The season purchase confirmation window 380 can be presented to a user after the user has initially requested to buy a particular media season. For example, the user can select the buy season button 374 illustrated in FIG. 3C, and then be presented with the season purchase confirmation window 380.

The season purchase confirmation window 380 includes a media source portion 382 and a media season portion 384. The media source portion 382 indicates that a “Media Store” source has been selected, such that the media season portion 384 is displaying information provided by an on-line media store. The media season portion 384 includes a confirmation area 386 and an episode listing area 388. The episode listing area 388 is similar to the episode listing area 368 illustrated in FIG. 3C. The confirmation area 386 provides information to the user so that the user can confirm purchase of the media season. Here, in this implementation, the media season pertains to a show. The confirmation information area 368 includes a show description 390, a show graphic 392, and a show price 394. In addition, an email reminder regarding new episodes can be enabled or disabled as desired by the user through use of a user interface control (e.g., check-box) 396. Further, the media confirmation area 386 includes a “Cancel” button 398 and a “Buy” button 399. In the event that the user elects to not confirm the media season purchase, the user selects the “Cancel” button 398. On the other hand, if the user desires to confirm the purchase of the media season, the user selects the “Buy” button 399.

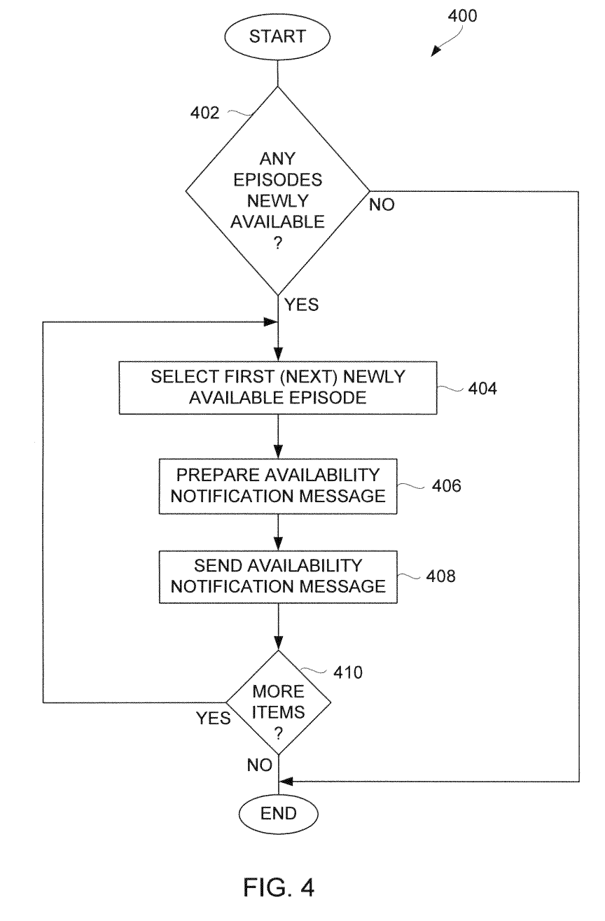

FIG. 4 is a flow diagram of an episode notification process 400 according to one embodiment of the invention. The episode notification process 400 begins with a decision 402. The decision 402 determines whether any episodes are newly available. Here, the decision 402 determines whether any episodes have recently been made available on the on-line media store such that they can now be delivered to requesting users. Typically, the episodes are associated with shows (e.g., television shows) or events (e.g., sporting events) that have been broadcast. Soon after a show is broadcast, the digital media content can be made available to the on-line media store so that the episode can be made available to those users that have purchased the corresponding media season.

When the decision 402 determines that there are episodes that are newly available, the episode notification process 400 performs processing operations for each of the episodes that are now newly available. In particular, a first newly available episode is selected 404. Next, an availability notification message is prepared 406. The availability notification message is then sent 408 to the appropriate users that have purchased the media season for which the episode pertains. As an example, the availability notification message can be implemented as an electronic mail (email) message. However, as noted in FIG. 3D, the purchaser can enable or disable receiving of notification messages (e.g., using a user interface control 396).

Following the operation 408, the episode notification process 400 determines at decision 410 whether more episodes are to be processed. In other words, when the decision 410 determines that there are other newly available episodes to be processed, the episode notification process 400 returns to repeat the operation 404 so that a next newly available episode can be similarly processed. Alternatively, when the decision 410 determines that there are no more other newly available episodes to be processed, the episode notification process 400 is complete and ends.

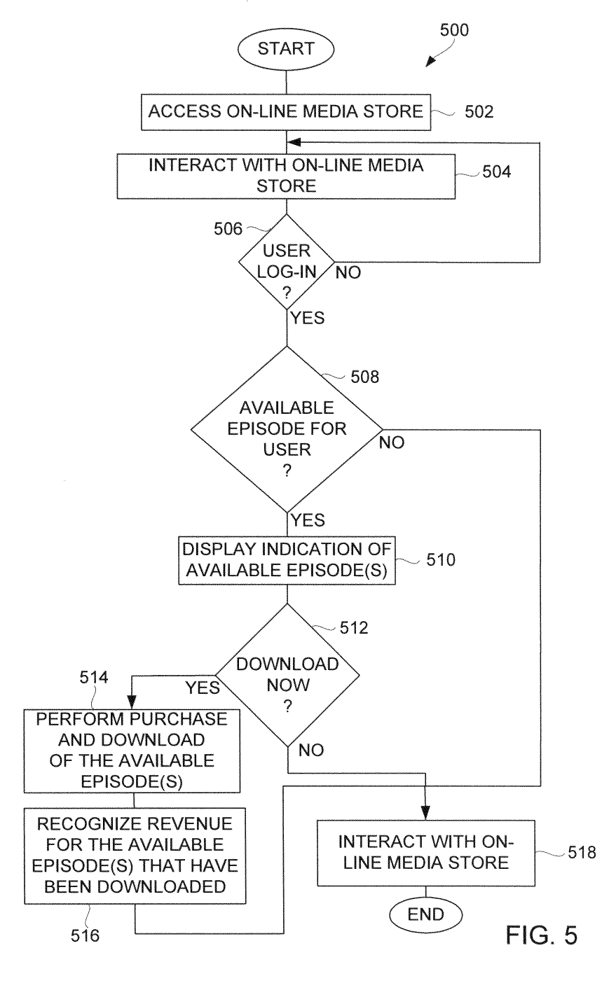

FIG. 5 is a flow diagram of an episode delivery process 500 according to one embodiment of the invention. The episode delivery process 500 concerns the eventual purchase and delivery of episodes of a media season to requesting users that have previously purchased the media season.

The episode delivery process 500 initially involves access 502 to an on-line media store. Typically, a user gains access 502 to the on-line media store via a data network, such as the Internet. After the user has access 502 to the on-line media store, the user can interact 504 with the on-line store. Certain interactions with the on-line media store, such as purchasing and downloading, require that the user be a registered user. In this regard, the on-line media store requires that a user log in to authenticate that the user is indeed a registered user of the on-line media store. Hence, when the interaction 504 requires such login, a decision 506 determines whether the user has successfully logged in to the on-line media store. When the decision 506 determines that the user has not yet logged in, then the episode delivery process 500 returns to repeat the operation 504 for other interaction with the on-line media store.

On the other hand, when the decision 506 determines that the user has successfully logged-in, a decision 508 determines whether there are any available episodes for the user. When the decision 508 determines that there are one or more available episodes for the user, an indication of the one or more available episodes is displayed 510 for the user. For example, a dialog box can be presented on a display screen that the user is able to view. The dialog box can list the one or more available episodes and allow the user to initiate download of the one or more available episodes.

Thereafter, a decision 512 determines whether the user desires to download the one or more available episodes at this time. When the decision 512 determines that the user does desire to download one or more of the available episodes, download of one or more of the available episodes is performed 514. Also, the revenue associated with the one or more of the available episodes that have been downloaded can then be recognized 516. Alternatively, when the decision 512 determines that none of the available episodes are to be downloaded, the operations 514 and 516 are bypassed. In this case, the user can choose to either defer the download of the one or more available episodes or cancel the media season. Following the decision 512 when download is not performed, or following the operation 516 following download and revenue recognition, additional interaction 518 with the on-line media store can be provided for the user. Additionally, following the decision 508 when there are no available episodes for the user, the episode delivery process 500 bypasses the operations 510-516 and proceeds to permit the additional interaction 518 with the on-line media store. Eventually, when no further interaction 518 with the on-line media store is desired, the episode delivery process 500 ends.

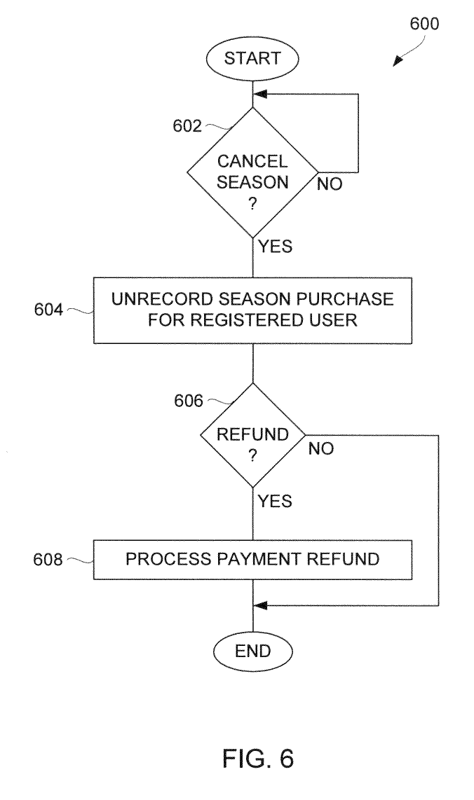

In addition, even after a media season has been purchased, the purchaser (i.e., registered user) can subsequently cancel the media season. FIG. 6 is a flow diagram of a season cancellation process 600 according to one embodiment of the invention. The season cancellation process 600 begins with a decision 602 that determines whether a media season is to be cancelled. When the decision 602 determines that the media season is not to be cancelled, then the season cancellation process 600 is effectively not invoked. On the other hand, when the decision 602 determines that the media season is to be cancelled, the season cancellation process 600 is invoked and processing continues. When the processing continues, the season purchase for the registered user is unrecorded 604. For example, the previous indication recorded to the recorded users 210 within the media season management system 200 illustrated in FIG. 2A can be removed so that the system no longer acknowledges that the registered user is the purchaser of the associated media season. In addition, a decision 606 can determine whether a refund is due to the registered user. Typically, the user is charged for the episodes that the user has received. In which case, a refund may not be due to the registered user. However, in other cases, the user may be permitted to get a refund even though they cancel a previously purchased media season. Hence, the decision 606 determines whether a refund is due to the registered user. When the decision 606 determines that a refund is due to the registered user, a payment refund can be processed 608 so that the registered user receives the appropriate refund. On the other hand, when the decision 606 determines that a refund is not due, the block 608 is bypassed. Following the block 608, or its being bypassed, the season cancellation process 600 ends.

Additionally, a season management page can be made available to a user. The season management page can allow the user to view status, cancel or otherwise manage any of the media seasons that they may have purchased. For example, the season management page could display a list of active media seasons that are associated with the user (e.g., associated with a user's account with the on-line media store). Then, through interaction with the season management page, the user can cancel one or more of the media seasons. The user might also be able to check the status of the media seasons. Once one of the media seasons is completed or fulfilled (e.g., all episodes downloaded), the media season is completed and can be removed from the list of active media seasons and, if desired, can be added to a list of completed media seasons and/or a purchase history page that is also available to the user.

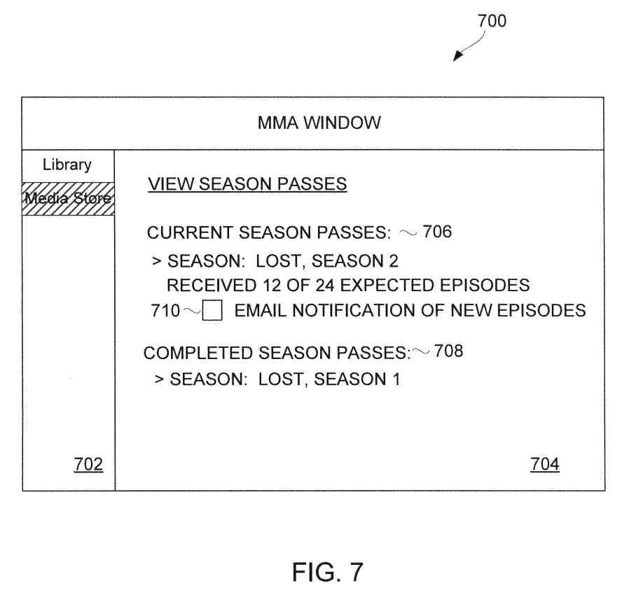

FIG. 7 is a representative season status window 700 according to one embodiment of the invention. The season status window 700 allows a user to receive status information regarding media seasons they have previously purchased. In particular, the season status window 700 includes a media source portion 702 and a media status portion 704. The media source portion 702 indicates the media source for the information presented in the media status portion 704. As shown in FIG. 7, the media source portion 702 indicates that the media source is a “Media Store,” namely, the on-line media store. The media status portion 704 includes media season status information. The media season status information presented in the media status portion 704 includes current season passes 706 and completed season passes 708. A season pass corresponds to a media season. For each of the season passes, the seasons that have been purchased can be identified as well as an indication of the extent to which the season has been provided. In addition, a user interface control 710 (e.g., check-box) can be presented so that email notifications of new episodes can be enabled or disabled.

In accordance with another aspect, certain embodiments of the invention can provide sets of digital media assets. Each of the sets of digital media assets can pertain to a particular artist, group, developer, label, producer, ranking, popularity, event, series, season, etc. Each of the sets of digital media assets can include one or more different types of digital media assets. Through use of an on-line media store, users can purchase sets of digital media assets. However, at the time of purchase, the specific digital media assets included within the sets of the related digital media assets can be partially or completely unknown. However, in one embodiment, the number of digital media assets to be included in a set of digital media assets can be known or estimated.

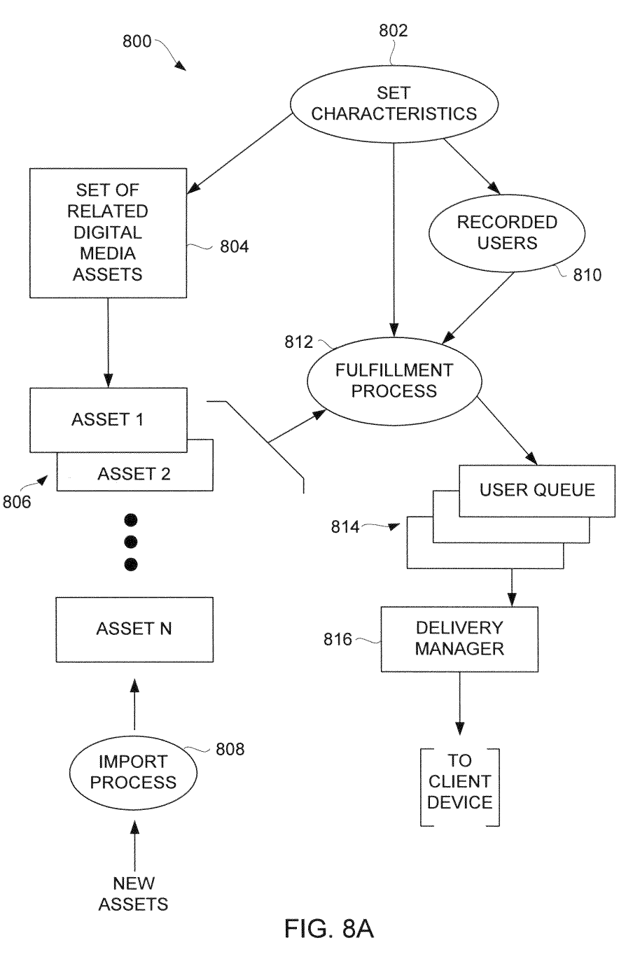

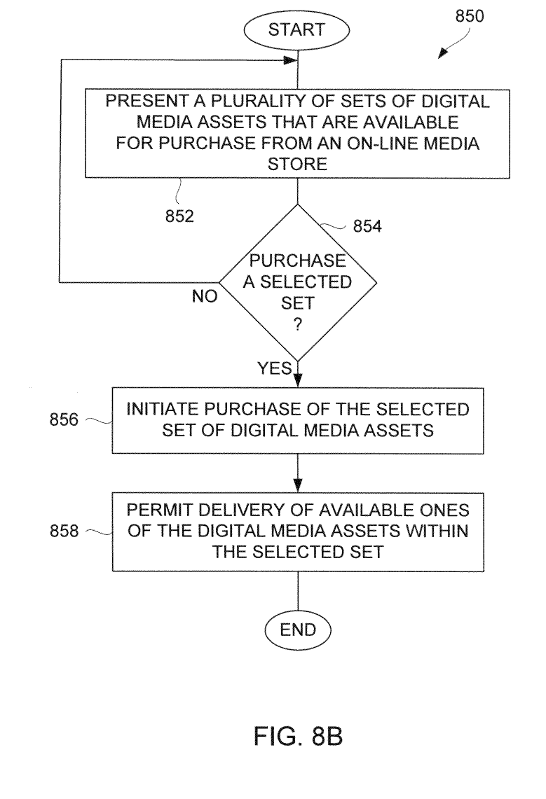

FIG. 8A is a diagram of a media set management system 800 according to one embodiment of the invention. The media set management system 800 can be provided by the media store server 102 and/or the digital media manager 114 illustrated in FIG. 1 or some other server associated therewith.

The media set management system 800 includes set characteristics 802 for each of a plurality of media sets. The set characteristics 802 describe attributes of the media sets which are made available and managed by the media set management system 800. For example, the attributes of a media set can include title, price, type, start and end dates (or duration), number of expected media assets, countries of distribution, etc. Each of the media sets has a related series of digital media assets associated therewith. For example, a particular media set can have an associated set of related digital media assets 804. The set of related digital media assets 804 pertains to a group of digital media assets 806 that are associated with the particular media set. For example, the media set can pertain to a particular artist, and thus the set of related digital media assets 804 can include a plurality of digital media assets that pertain to the particular artist. As another example, the media set can pertain to a group of two or more artists, and thus the set of related digital media assets 804 can include a plurality of digital media assets that pertain to one or more of the artists. As another example, the media set can pertain to a symphony, and thus the set of related digital media assets 804 can includes a plurality of performances by the symphony (such as a season of performances). In still another example, the media set can pertain to a concert series, and thus the set of related digital media assets 804 can includes a plurality of performances associated with the concert series. Typically, new digital media assets that are to be included in one or more related set of digital media assets are submitted and thus made available over a period of time. As these new digital media assets become available from content providers, the new digital media assets can be imported into the media set management system 800 by an import process 808. The import process 808 can automatically place (or associated) the new digital media assets with the appropriate set(s) of related digital media assets 804. To assist with the automatic import process 808, the new digital media assets can contain metadata or submission information that describes certain characteristics of the new digital media assets.

The media set management system 800 also maintains recorded users 810. The recorded users are those users that are recorded as having access to a media set. Typically, a user will become a recorded user when the user purchases access to a particular media set. The recorded users 810 are thus associated with the particular media set that they have permission to access. The recorded users 810 can also indicate one or more preferences they have regarding fulfillment of their access to the media sets.

The media set management system 800 also includes a fulfillment process 812. The fulfillment process 812 operates to recognize the presence of new digital media assets that are part of a set of related digital media assets 804, and then determines if there are any recorded users 810 that are to be notified about the presence of the new digital media assets regarding a particular media set that they have permission to access. When the fulfillment process 812 determines that a particular user is to be provided with one or more of the new digital media assets 806, then the fulfillment process 812 can provide the one or more of the new media assets 806 to a user queue 814 associated with the particular user.

The media set management system 800 can also include a delivery manager 816. The delivery manager 816 operates to assist with the delivery of the new digital media assets from the user queues 814 to the corresponding client devices. For example, the delivery manager 816 can electronically deliver (e.g., download) the new digital media assets from the appropriate user queue 814 to the corresponding client device when requested by a user or automatically upon accessing an on-line media store that incorporates or couples to the media set management system 800. In addition, in one embodiment, the fulfillment process 812 could initiate or provide an email notification to the particular user that the new digital asset(s) are now available to be acquired (e.g., downloaded) by the particular user.

FIG. 8B is a flow diagram of a media set acquisition process 850 according to one embodiment of the invention. The media set acquisition process 850 can be associated with a media store server that provides or supports an on-line media store. For example, the media set acquisition process 850 can be associated with the media store server 102 illustrated in FIG. 1 or some other server associated therewith.

The media set acquisition process 850 initially presents 852 a plurality of sets of digital media assets that are available for purchase from an on-line media store. The digital media assets can pertain to a media set, such as a set of digital media assets pertaining to a particular artist, show or event. For example, the media set can pertain to all digital media assets released by the artist Bon Jovi from Jan. 1, 2009 to Jun. 30, 2009. As another example, the media set can pertain to digital media assets associated with the 2008 Shoreline Concert Series. The plurality of available sets can typically be presented 852 on a display device of a client device associated with a user. The user typically interacts with the client device so as to browse, search or otherwise navigate an on-line media store to review different available sets. At some point, the user can opt to purchase one of the plurality of available sets being presented 852. Hence, a decision 854 determines whether a selected set is to be purchased. When the decision 854 determines that a selected set is not to be purchased, the media set acquisition process 850 can return to repeat the block 852 so that the user can continue to review the available sets. On the other hand, when the decision 854 determines that a set of digital media assets is to be purchased, purchase of the selected set of digital media assets is initiated 856. The processing of the purchase can be performed immediately or can be deferred or can be partially performed. After the purchase of the selected set of digital media assets has been at least initiated 856, delivery of available ones of the digital media assets within the selected set can be permitted 858. When the delivery of the available ones of the digital media assets is permitted 858, the purchaser (user) is able to gain access to the available digital media assets. For example, the available digital media assets might immediately be downloaded to the client device associated with the purchaser, or the available digital media assets can be downloaded at a later point in time when more convenient for the purchaser. Following the block 858, the media set acquisition process 850 ends.

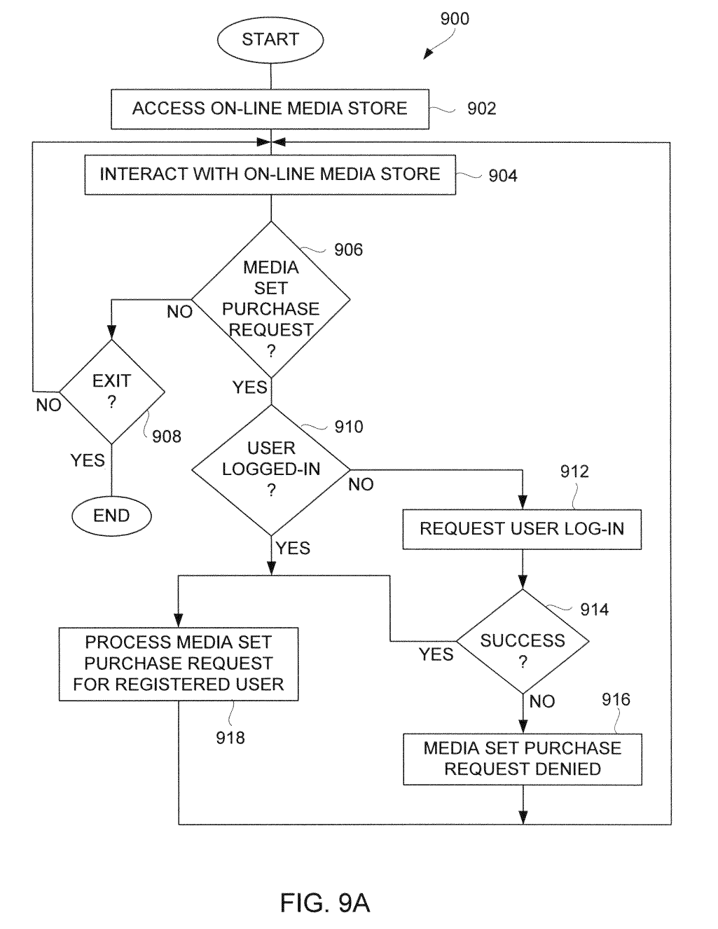

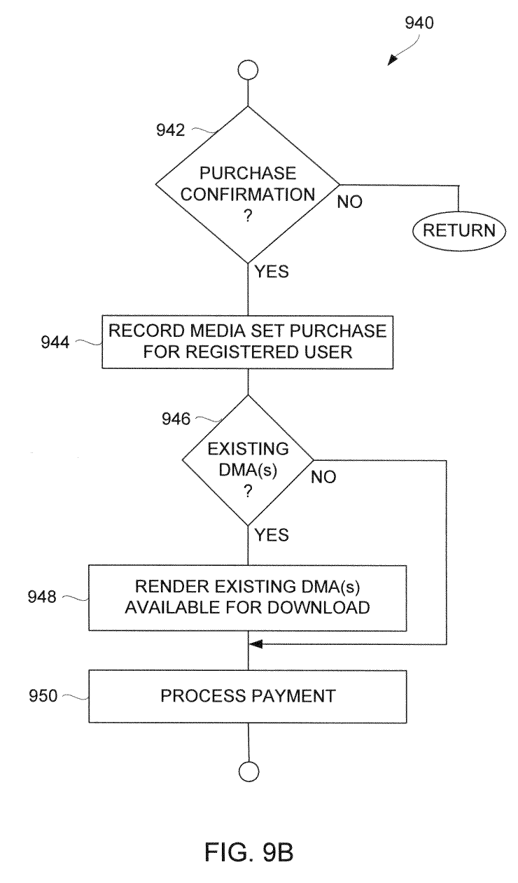

FIG. 9A is a flow diagram of a media set purchase request process 900 according to one embodiment of the invention. The media set purchase request process 900 begins with access 902 to an on-line media store. Typically, a user will access 902 the on-line media store via a data network, such as the Internet. Once the user has accessed 902 the on-line media store, the user can interact 904 with the on-line media store. The interaction 904 with the on-line media store can, for example, involve searching, browsing, displaying, previewing, purchasing, and/or organizing digital media assets. Although the media set purchase request process 900 is primarily provided by a server, such as the media store server 102 illustrated in FIG. 1, the access 902 and the interaction 904 can be facilitated by a media management application operating on a client device, such as the client device 104 illustrated in FIG. 1.

Next, a decision 906 determines whether a media set purchase request has been received. When the decision 906 determines that a media set purchase request has not been received, a decision 908 determines whether the media set purchase request process 900 should be exited. When the decision 908 determines that the media set purchase request process 900 should not be exited, then the media set purchase request process 900 returns to repeat the operation 904 and subsequent operations. Alternatively, when the decision 906 determines that the media set purchase request process 900 should exit, then the media set purchase request process 900 ends. In one embodiment, when media store content for a media set is displayed by the on-line media store, a “media set purchase” control (e.g., button) can be presented to the user. By selection of the “media set purchase” control, the user can initiate a media set purchase request.

On the other hand, when the decision 906 determines that a media set purchase request has been received, then a decision 910 determines whether the user is logged-in to the on-line media store. When the decision 910 determines that the user is not currently logged-in to the on-line media store, a user login is requested 912. A decision 914 then determines whether the login has been successful. As an example, the user will submit login information, such as a user name and/or password, which is evaluated to determine whether the user is permitted to login. When the decision 914 determines that login was not successful, the media set purchase request is denied 916. Alternatively, when the decision 910 determines that the user is already logged-in, or when the decision 914 determines that the user has just successfully logged-in, the media set purchase for a particular set of related digital media assets is processed 918 for the registered user. For example, the media set purchase can be purchased such that it is associated with the registered user (e.g., associated with the user account for the registered user) so that the registered user is able to acquire the various digital media assets within the particular media set that has been purchased. Following the operation 916 or 918, the media set purchase request process 900 returns to repeat the operation 904 and subsequent operations so that additional interaction 904 with the on-line media store is permitted, including making additional media set purchase requests if so desired.

FIG. 9B is a flow diagram of a media set purchase process 940 according to one embodiment of the invention. The media set purchase process 940 is, for example, processing suitable for being performed by the block 918 of the media set purchase request process 900 illustrated in FIG. 9A.

The media set purchase process 940 begins with a decision 942. The decision 942 determines whether the purchaser (user) has confirmed purchase of the particular media set being purchased. In one embodiment, the media set is a set of related digital media assets. When the decision 942 determines that the user has not confirmed purchase of the media set, then the media set purchase process 940 returns back to the block 904 illustrated in FIG. 9A, thereby undoing the previous media set purchase request.

On the other hand, when the decision 942 determines that the user has confirmed purchase of the particular media set, the media set purchase for the registered user is recorded 944. For example, the media set purchase can be recorded 944 in the recorded users 810 of the media set management system 800 illustrated in FIG. 8A.

After the media set purchase for the registered user has been recorded 944, a decision 946 determines whether there are existing digital media assets (DMAs) for the media set that has been purchased. When the decision 946 determines that there are existing digital media assets, then the existing digital media assets are rendered 948 available for download. This permits the registered user to acquire the existing digital media assets at or soon after the time of purchase of the media set. Payment for the media set is also processed 950. Typically, the payment is processed such that the total cost of the media set is initially imposed or charged to the registered user. Following the block 950, the media set purchase process 940 ends and processing can return to block 904 of the media set purchase request process 900 illustrated in FIG. 9A so that the user can continue to interact with the on-line media store for various operations, including again purchasing a media set.

Although the media set purchase process 940 permits the registered user to acquire the existing digital media assets at or soon after the time of purchase of the media set, in some embodiments there are no existing digital media assets to be delivered.

The total cost for a media set is paid by the purchaser. The total cost can be a total set cost for the media set. In one implementation, the total set cost is less than the sum of the individual costs of all the digital media assets included or to be included in the media set. Further, the media set may also include bonus material, which made pertain to one or more additional digital media assets or digital non-media assets. In one embodiment, the bonus material is only available from the on-line media store with the purchase of the media set.

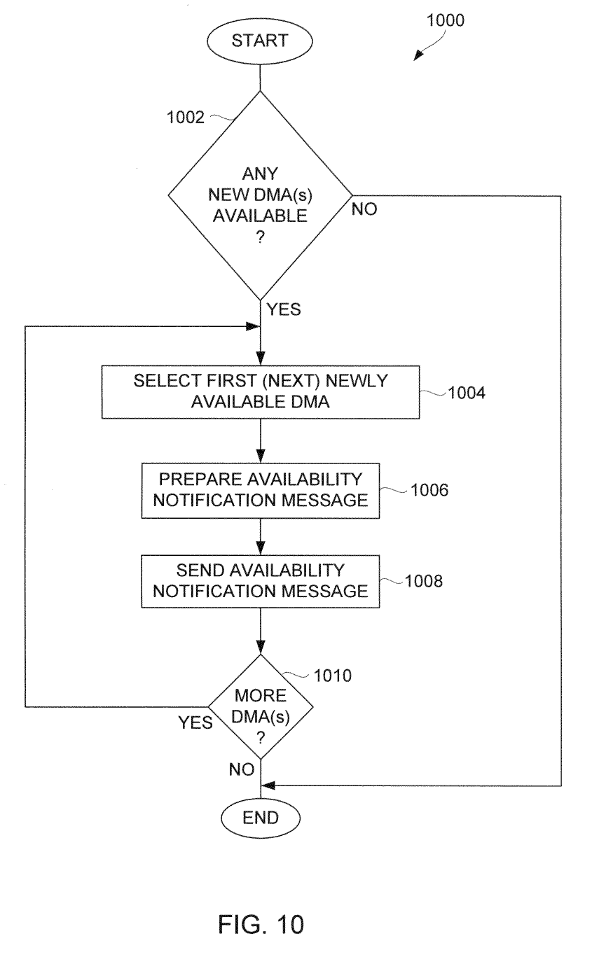

FIG. 10 is a flow diagram of an asset notification process 1000 according to one embodiment of the invention. The asset notification process 1000 begins with a decision 1002. The decision 1002 determines whether any digital media assets are newly available. The digital media assets being determined are those digital media assets that are associated with media sets. Here, the decision 1002 determines whether any digital media assets have recently been made available on the on-line media store such that they can now be delivered to requesting users. In this scenario, the users have previously purchased at least one media set and are thus eligible to receive digital media assets (associated with the respective media sets) that later become available (or come into existence).

When the decision 1002 determines that there are digital media assets that are newly available, the asset notification process 1000 performs processing operations for each of the digital media assets that are now newly available. In particular, a first newly available digital media asset is selected 1004. Next, an availability notification message is prepared 1006. The availability notification message is then sent 1008 to the appropriate users that have purchased the media set for which the digital media assets pertains. As an example, the availability notification message can be implemented as an electronic mail (email) message. However, the purchaser can enable or disable receiving of such notification messages.

Following the operation 1008, the asset notification process 1000 determines at decision 1010 whether one or more digital media assets are to be processed. In other words, when the decision 1010 determines that there are other newly available digital media assets to be processed, the asset notification process 1000 returns to repeat the operation 1004 so that a next newly available digital media assets can be similarly processed. Alternatively, when the decision 1010 determines that there are no more other newly available digital media assets to be processed, the asset notification process 1000 is complete and ends.

In the asset notification process 1000, a notification message can be sent 1008 when a new digital media asset associated with a media set becomes available. Such notification message can be on a per digital media asset basis. Alternatively, the notification message can be sent once daily and in effect contain all the new digital media assets that are newly available, such that each user need only receive at most one notification message per-day.

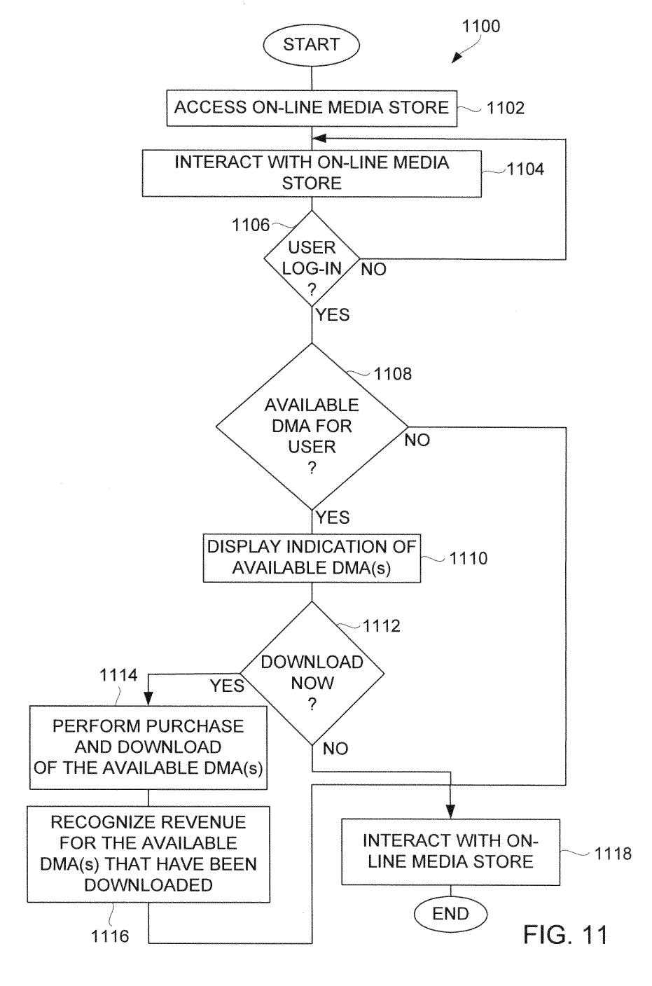

FIG. 11 is a flow diagram of an asset delivery process 1100 according to one embodiment of the invention. The asset delivery process 1100 concerns the eventual purchase and delivery of digital media assets of a media set to requesting users that have previously purchased the media set.

The asset delivery process 1100 initially involves access 1102 to an on-line media store. Typically, a user gains access 1102 to the on-line media store via a data network, such as the Internet. After the user has access 1102 to the on-line media store, the user can interact 1104 with the on-line store. Certain interactions with the on-line media store, such as purchasing and downloading, require that the user be a registered user. In this regard, the on-line media store requires that a user log in to authenticate that the user is indeed a registered user of the on-line media store. Hence, when the interaction 1104 requires such login, a decision 1106 determines whether the user has successfully logged in to the on-line media store. When the decision 1106 determines that the user has not yet logged in, then the asset delivery process 1100 returns to repeat the operation 1104 for other interaction with the on-line media store.

On the other hand, when the decision 1106 determines that the user has successfully logged-in, a decision 1108 determines whether there are any available digital media assets for the user. When the decision 1108 determines that there are one or more available digital media assets for the user, an indication of the one or more available digital media assets is displayed 1110 for the user. For example, a dialog box can be presented on a display screen that the user is able to view. The dialog box can list the one or more available digital media assets and allow the user to initiate download of the one or more available digital media assets.

Thereafter, a decision 1112 determines whether the user desires to download the one or more available digital media assets at this time. When the decision 1112 determines that the user does desire to download one or more of the available digital media assets, download of one or more of the available digital media assets is performed 1114. Also, the revenue associated with the one or more of the available digital media assets that have been downloaded can then be recognized 1116. Alternatively, when the decision 1112 determines that none of the available digital media assets are to be downloaded at this time, the operations 1114 and 1116 are bypassed. In this case, the user can choose to either defer the download of the one or more available digital media assets or cancel the media set. Following the decision 1112 when download is not performed, or following the operation 1116 following download and revenue recognition, additional interaction 1118 with the on-line media store can be provided for the user. Additionally, following the decision 1108 when there are no available digital media assets for the user, the asset delivery process 1100 bypasses the operations 1110-1116 and proceeds to permit the additional interaction 1118 with the on-line media store. Eventually, when no further interaction 1118 with the on-line media store is desired, the asset delivery process 1100 ends.

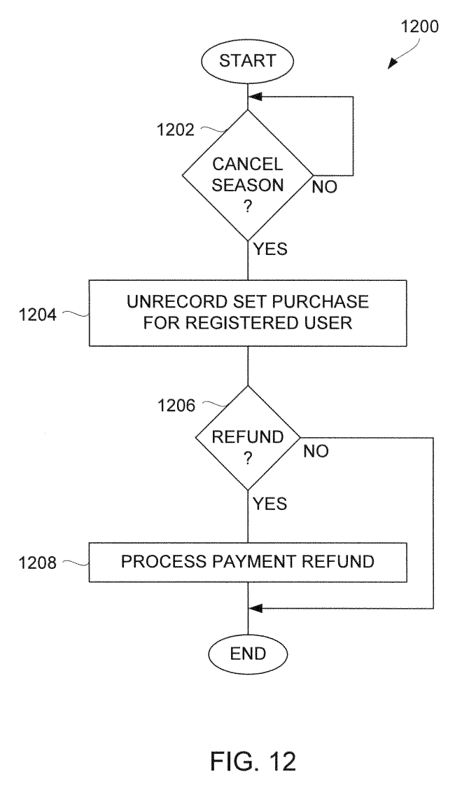

In addition, even after a media set has been purchased, the purchaser (i.e., registered user) can subsequently cancel the media set. FIG. 12 is a flow diagram of a media set cancellation process 1200 according to one embodiment of the invention. The media set cancellation process 1200 begins with a decision 1202 that determines whether a media set is to be cancelled. When the decision 1202 determines that the media set is not to be cancelled, then the media set cancellation process 1200 is effectively not invoked. On the other hand, when the decision 1202 determines that the media set is to be cancelled, the media set cancellation process 1200 is invoked and processing continues. When the processing continues, the media set purchase for the registered user is unrecorded 1204. For example, the previous indication recorded to the recorded users 810 within the media set management system 800 illustrated in FIG. 8A can be removed so that the system no longer acknowledges that the registered user is the purchaser of the associated media set. In addition, a decision 1206 can determine whether a refund is due to the registered user. Typically, the user is charged for the media sets that the user has previously received. In which case, a refund may not be due to the registered user. However, in other cases, the user may be permitted to get a refund, such as a partial or pro-rata refund, even though they cancel a previously purchased media set. Hence, the decision 1206 determines whether a refund is due to the registered user. When the decision 1206 determines that a refund is due to the registered user, a payment refund can be processed 1208 so that the registered user receives the appropriate refund. On the other hand, when the decision 1206 determines that a refund is not due, the block 1208 is bypassed. Following the block 1208, or its being bypassed, the media set cancellation process 1200 ends.

Additionally, a media set management page can be made available to a user. The media set management page can allow the user to view status, cancel or otherwise manage any of the media sets that they may have purchased. For example, the media set management page could display a list of active media sets that are associated with the user (e.g., associated with a user's account with the on-line media store). Then, through interaction with the media set management page, the user can cancel one or more of the media sets. The user might also be able to check the status of the media sets. Once one of the media sets is completed or fulfilled (e.g., all digital media assets downloaded), the media set is completed and can be removed from the list of active media sets and, if desired, can be added to a list of completed media set and/or a purchase history page that is also available to the user.

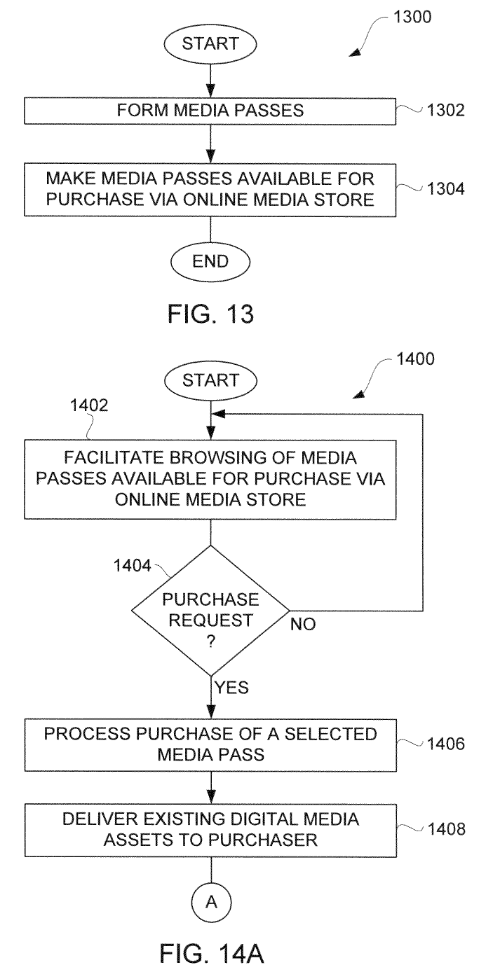

FIG. 13 is a flow diagram of a media pass availability process 1300 according to one embodiment of the invention. The media pass availability process 1300 can, for example, be performed by the media set management system 800 or the digital media manager 114 that receives submissions of digital media assets that are to be made available at an online media store. In some cases, the media pass availability process 1300 can be fully or substantially automated.

The media pass availability process 1300 can form 1302 one or more media passes. A media pass is a set of related digital media assets that are made available to users as a set or group. As one example, a media pass can pertain to a set of related digital media assets that are associated with a particular artist. As another example, a media pass can pertain to a set of related digital media assets that are associated with a particular label (e.g., BMI, Sony, etc.). In one implementation, a media pass can be associated with a predetermined duration of time during which media assets that are provided by a particular artist or label will become part of the media pass. When a media pass is initially formed 1302, none or some of the digital media assets that are part of the media pass can already be available (e.g., from an online media store), while other digital media assets can be undefined and provided at a later point in time. Hence, although the general characteristics of the media pass is defined upon formation 1302, the specific digital media assets to be included in the set of related digital media assets of the media pass can be determined at a later point in time.

After the one or more media passes are formed 1302, the one or more media passes can be made 1304 available for purchase via an online media store. In other words, once a media pass is formed, a media store server hosting the online media store can be configured to make the media pass available for purchase on the online media store. At time of purchase, the purchaser knows of the general characteristics of the media pass, but will not know all the specific digital media assets to be included in the set of related digital media assets of the media pass.

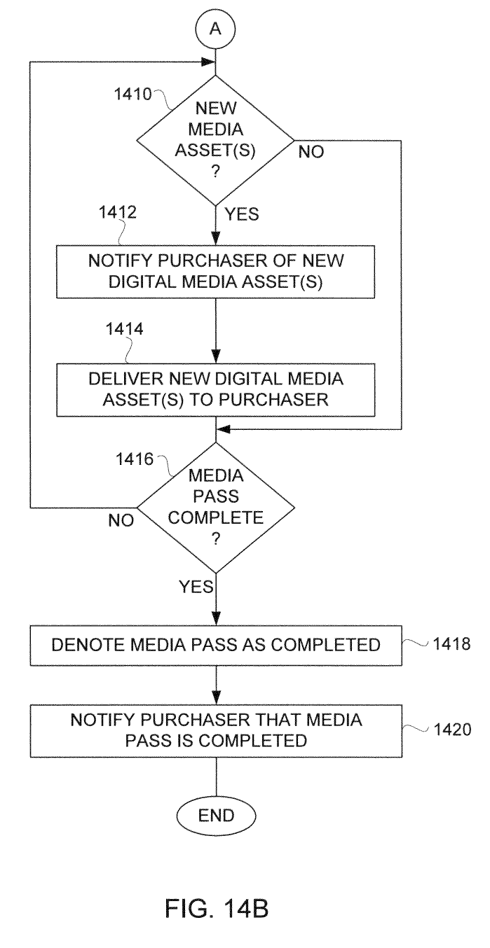

FIGS. 14A and 14B are flow diagrams of media pass acquisition process 1400 according to one embodiment of the invention. The media pass acquisition process 1400 can, for example, be performed by a media store server, such as the media store server 102 illustrated in FIG. 1, which hosts an online media store.

The media pass acquisition process 1400 can initially facilitate 1402 browsing of media passes that are available for purchase via an online media store. As noted above with respect to FIG. 13, media passes can be submitted or otherwise made available to the online media store using processing, such as the media pass availability process 1300. Users of the online media store can browse the media passes that are available for purchase. A decision 1404 can determine whether a purchase request has been received from one of the users of the online media store. When the decision 1404 determines that a purchase request has not been received, the media pass acquisition process 1400 can return to repeat the block 1402 so that the users can continue to browse media passes via the online media store.

On the other hand, when the decision 1404 determines that a purchase request has been received, the media pass acquisition process 1400 can continue to process the purchase and delivery the digital media assets associated with the media pass to the purchaser. More particularly, purchase of a selected media pass can be processed 1406. Here, the user through interaction with the online media store, has selected a media pass to be purchased. In doing so, the user pays the appropriate fee (or cost) for the media pass as part of the processing 1406. Then, any existing digital media assets of the selected media pass can be delivered 1408 to the user that has purchased the media pass. Here, as previously noted, a media pass can, at time of purchase, have some existing digital media assets with other digital media assets to be later identified. Hence, those of the digital media assets of the selected media pass that are in existence at the time of purchase can be delivered 1408.

Next, a decision 1410 determines whether a new media asset for the selected media pass has been made available since the time of purchase. Here, the media pass acquisition process 1400 can monitor the submission of digital media assets to the online media store so that prior purchasers of media passes can receive subsequently submitted digital media assets that are to be included in the media passes. Specifically, when the decision 1410 determines that a new media asset for the selected media pass has been made available to the online media store, the purchaser of the selected media pass can be notified 1412 of the new digital media asset that is part of the selected media pass. In addition, the new digital media asset can also be delivered 1414 to the purchaser. Alternatively, when the decision 1410 determines that there are no new digital media assets of the media passes, the blocks 1412 and 1414 can be bypassed.

Following the block 1414 or its being bypassed, a decision 1416 can determine whether the media pass has been completed. A media pass can be deemed completed all the anticipated media assets have been received and made available to the media pass and its purchasers. The media pass can also be deemed completed when a predetermined period of time associated with media pass as expired. For example, a media pass might have a predetermined duration of six (6) months during which media assets can be received and included within the media pass. When the decision 1416 determines that the media pass is not yet completed, the media pass acquisition process 1400 can return to repeat the block 1410 to await availability of another a new media asset for the selected media pass.

On the other hand, when the decision 1416 determines that the media pass is completed, the media pass can be denoted 1418 as completed. In one embodiment, the online media store can continue to sell the media pass as a completed set of digital media assets. The completed set of digital media assets being sold can be modified for subsequent sale as a completed set by changes to price and/or content. For example, the selected media pass purchased before completion can provide “pass only” content to purchasers that will not otherwise be available to purchasers via the online media store. The “pass only” content and/or a price incentive can motivate purchasers to purchase the music before its completed. Furthermore, the purchaser of the selected media pass that is now completed can be notified 1420 that the selected media pass is now complete. The notification can be implemented by various different means, such as an electronic mail message, an account notification (via user account notification) or a custom web page (e.g., via online media store). Following the block 1420, the media pass acquisition process 1400 can end.

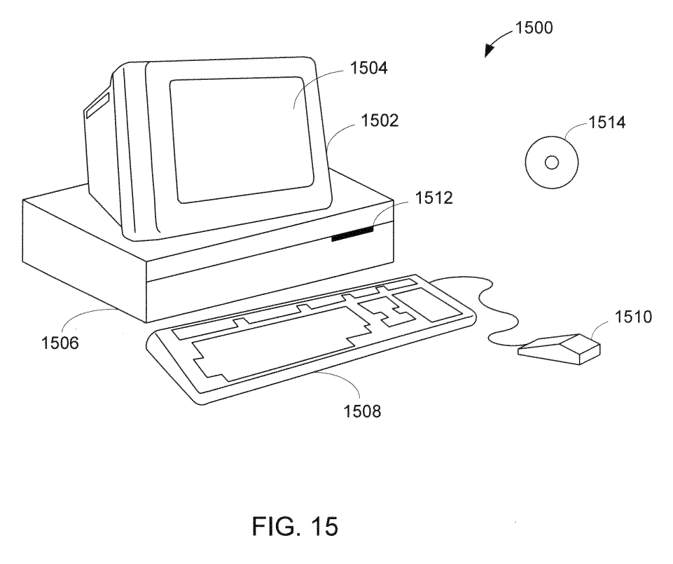

FIG. 15 shows an exemplary computer system 1500 suitable for use with the invention. Although the client device need not be a personal computer, the client device can be the exemplary computer system 1500 illustrated in FIG. 15. The computer system 1500 includes a display monitor 1502 having a single or multi-screen display 1504 (or multiple displays), a cabinet 1506, a keyboard 1508, and a mouse 1510. The cabinet 1506 houses a processing unit (or processor), system memory and a hard drive (not shown). The cabinet 1506 also houses a drive 1512, such as a CD-ROM or floppy drive. The drive 1512 can also be a removable hard drive, a Flash or EEPROM device, etc. Regardless, the drive 1512 may be utilized to store and retrieve software programs incorporating computer code that implements some or all aspects of the invention, data for use with the invention, and the like. Although CD-ROM 1514 is shown as an exemplary computer readable storage medium, other computer readable storage media including floppy disk, tape, Flash or EEPROM memory, memory card, system memory, and hard drive may be utilized. Additionally, a data signal embodied in a carrier wave (e.g., in a network) may be the computer readable storage medium. In one implementation, a software program for the computer system 1500 is provided in the system memory, the hard drive, the CD-ROM 1514 or other computer readable storage medium and serves to incorporate the computer code that implements some or all aspects of the invention.

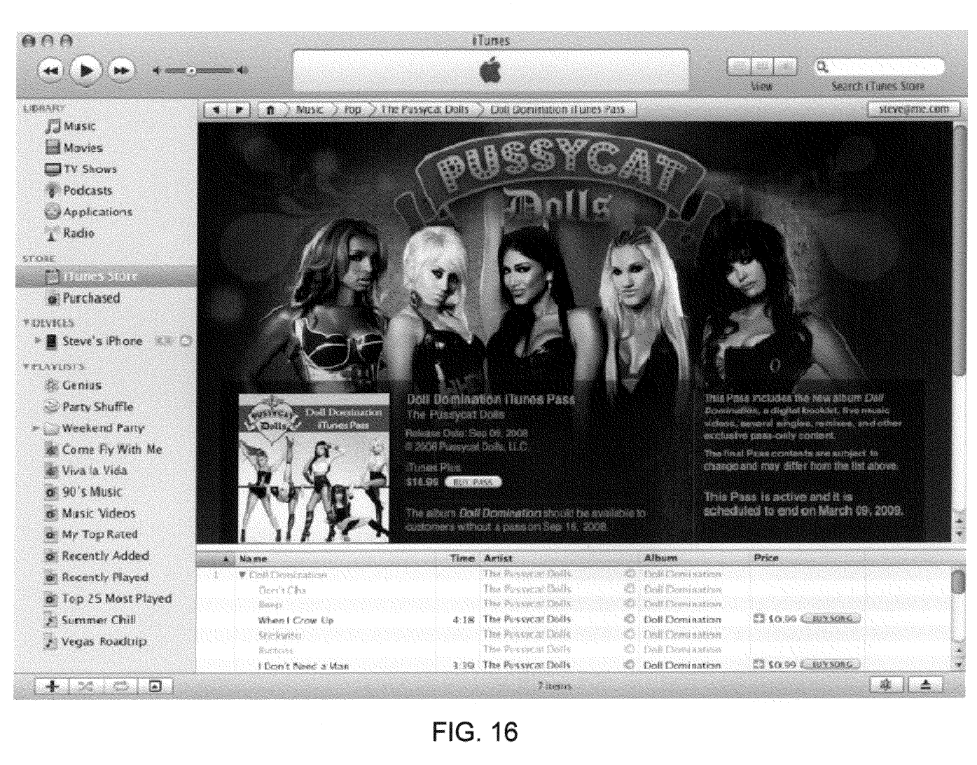

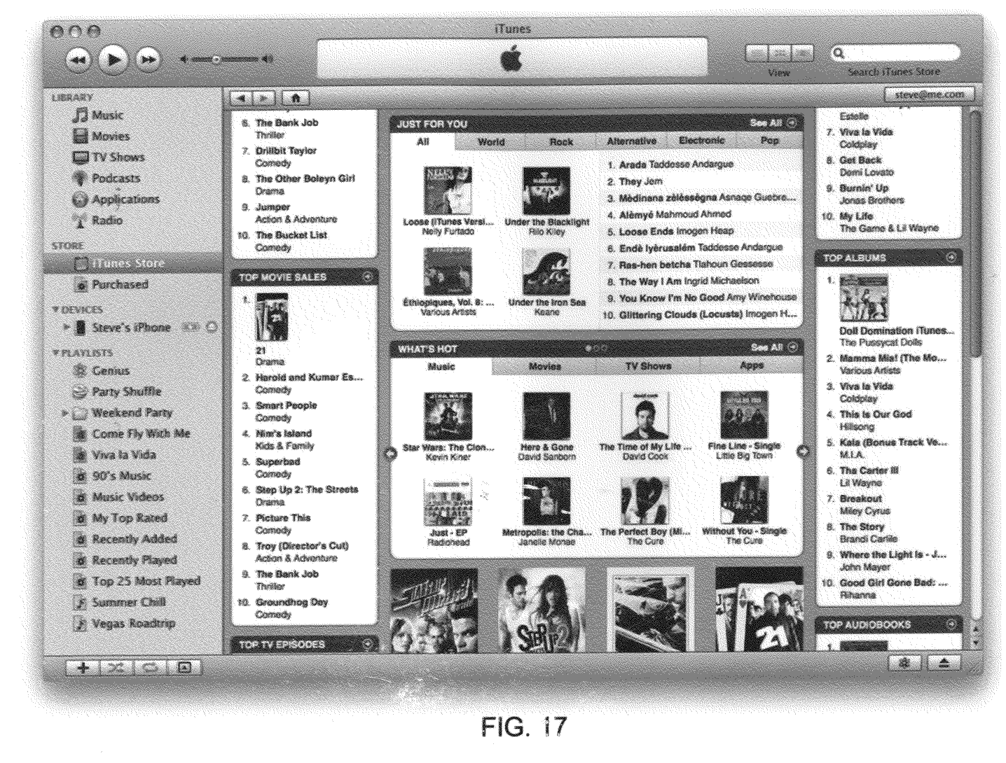

FIGS. 16-38 are screen illustrations associated with one or more embodiments of the invention. In these embodiments, the media set is referred to as a media pass or, more specifically, a “Music Pass” or “iTunes Pass”.

FIG. 16 is a screenshot of a media pass page according to one embodiment. The media pass page provides a name for the media pass, one or more artists for the media pass, release date, owner and a “Buy Pass” control. The media pass page can also include a brief description of the contents of the media pass. Still further, the media pass page can include a track listing of the digital media assets within the media pass.

FIG. 17 is a screenshot of a main page including music passes treated like an album according to one embodiment of the invention. For example, in the media pass “Doll Domination” is illustrated as one of the top albums. Upon selection of the illustrations or link associated with the media pass, a media pass page, such as illustrated in FIG. 16, can be displayed. As an example, the main page illustrated in FIG. 17 can pertain to a page being provided by the iTunes™ program available from Apple Inc.

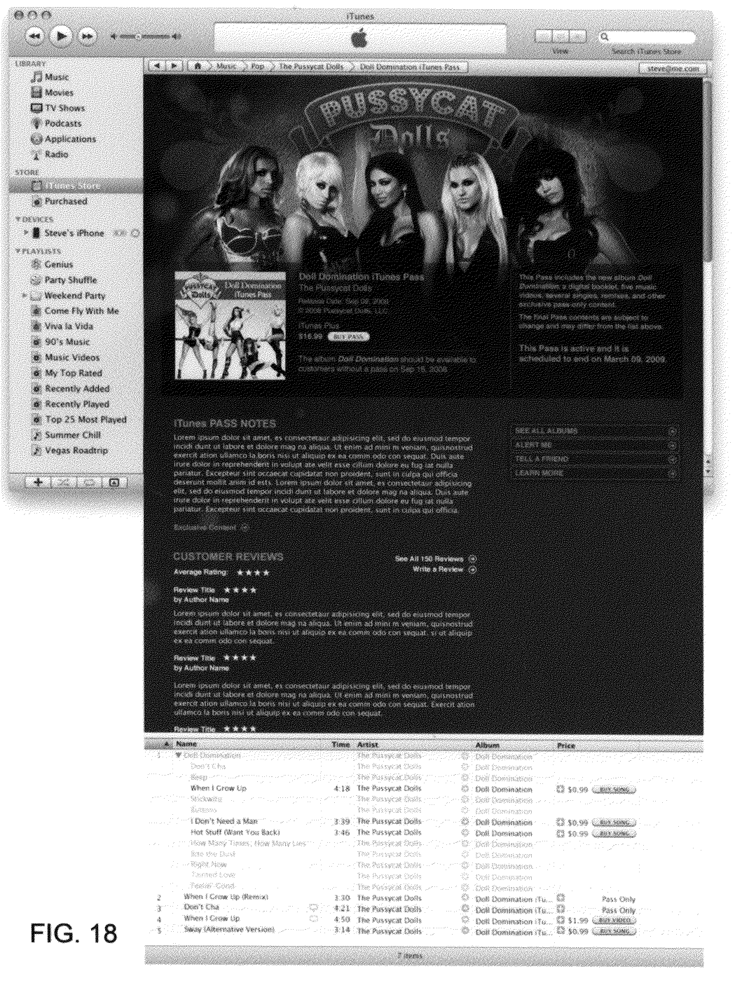

FIG. 18 is a screenshot of an expanded media pass page according to one embodiment of the invention. In the expanded media pass page can include a background graphic, artwork associated with the media pass, notes concerning the media pass, a link to exclusive content for the media pass, a track listing, a long description of the contents of the media pass, a disclaimer field, a predicted end date for the media pass, a short description of the contents of the media pass, a link to learn more about the media pass, and visual indications in the track listing to denote those media assets that are only available with the media pass or that are only available with a related album (and not with the media pass).

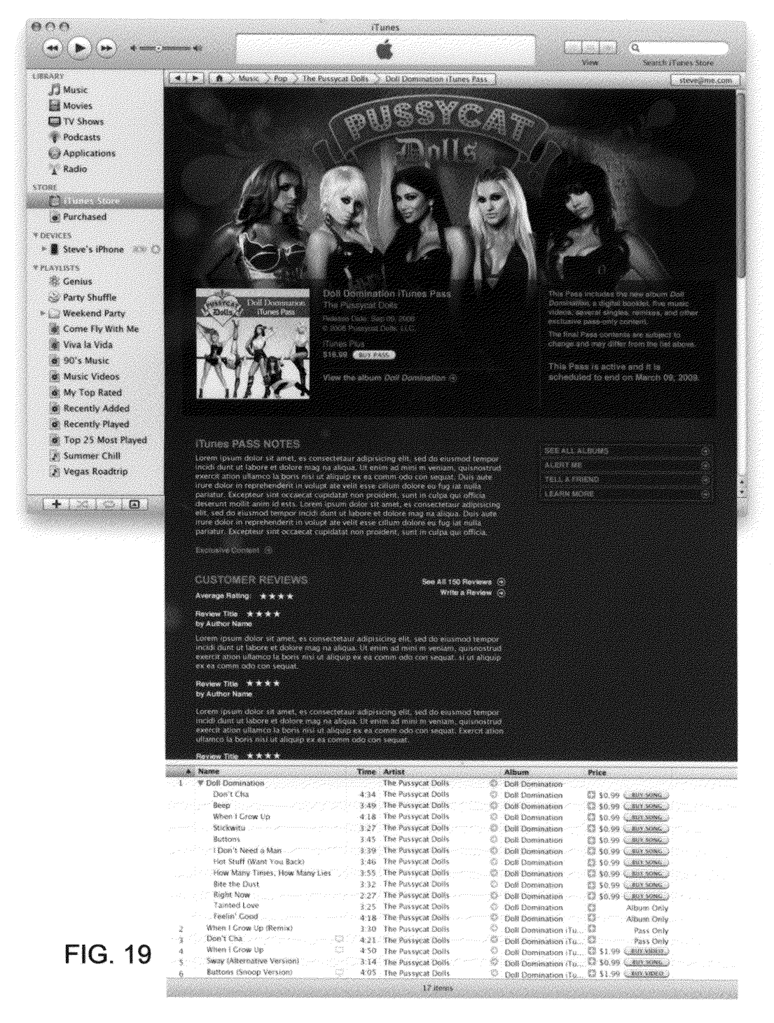

FIG. 19 is a screenshot of the expanded media pass page illustrated in FIG. 18 where the associated album has been released. In such case, the expanded media pass page further includes a link to an album page. The track listing can also further denote that media items (e.g., album tracks) are available for individual purchase (e.g., “Buy Song” controls).

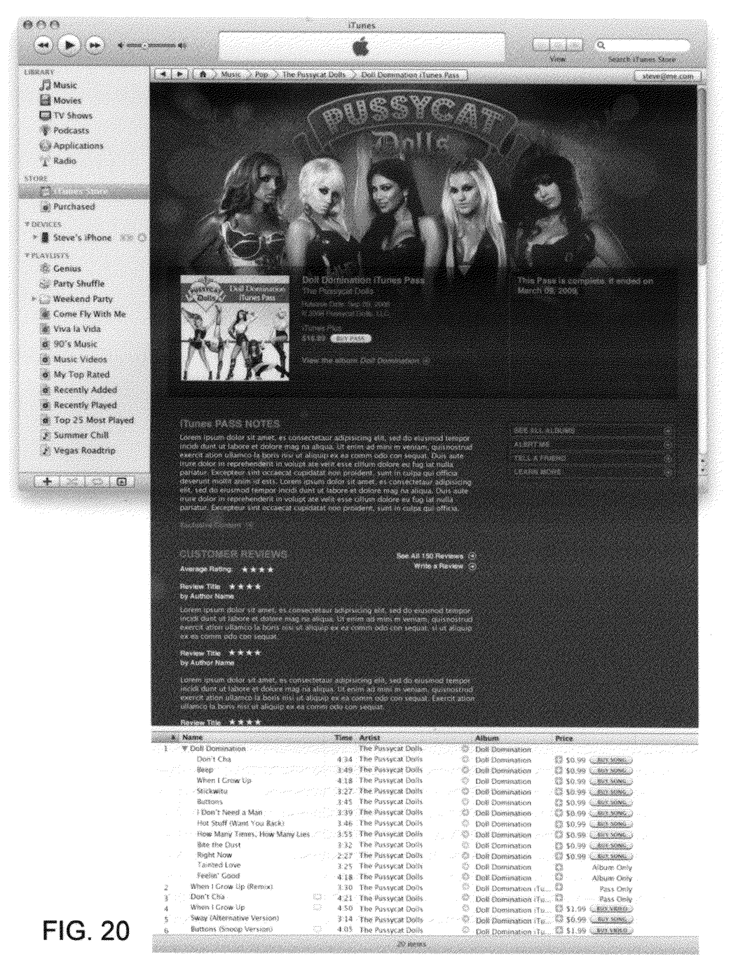

FIG. 20 is a screenshot of the expanded media pass page illustrated in FIG. 18 where the media pass is completed. Typically, when a media pass is originally configured, the various media assets to be eventually included within the media pass are not at that time available. However, some time later (e.g., within a predetermined period of time) the various media assets to be included within the media pass have all been released and therefore provided to and included within the media pass. For example, typically, the various media assets are associated with one or more albums, and the release of such albums causes the media pass to be completed. The expanded media pass page can also include an indication that the media pass is now completed. The media pass can also include a link to the associated album page.

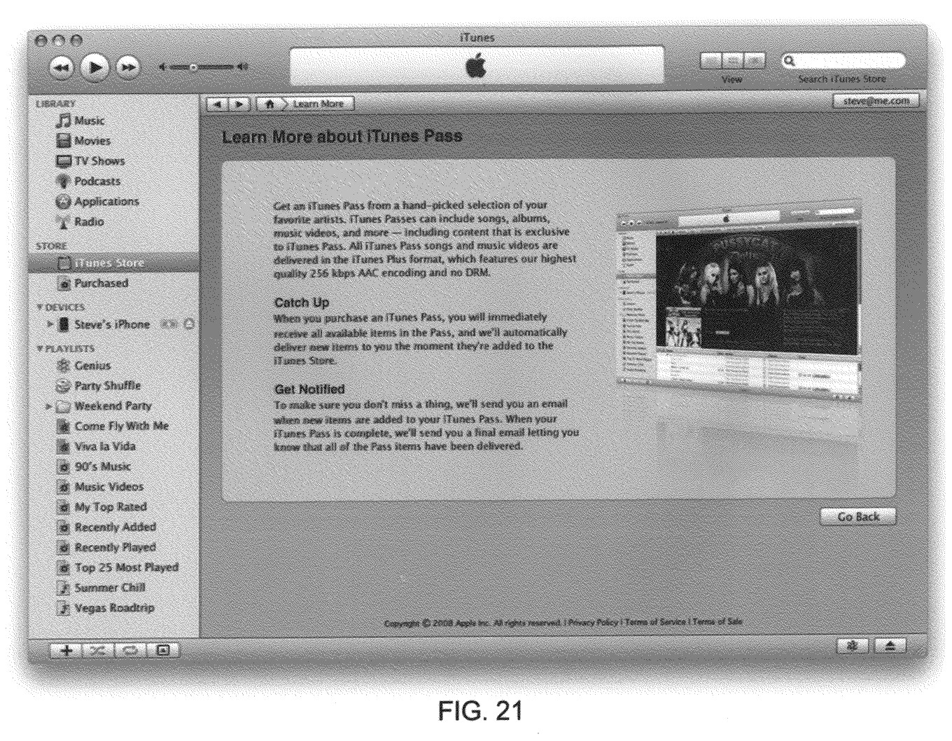

FIG. 21 is a screenshot of a learn more page according to one embodiment of the invention. The learn more page can be accessed by a link provided on a media pass page so that the user can obtain additional information on what the particular media pass is.

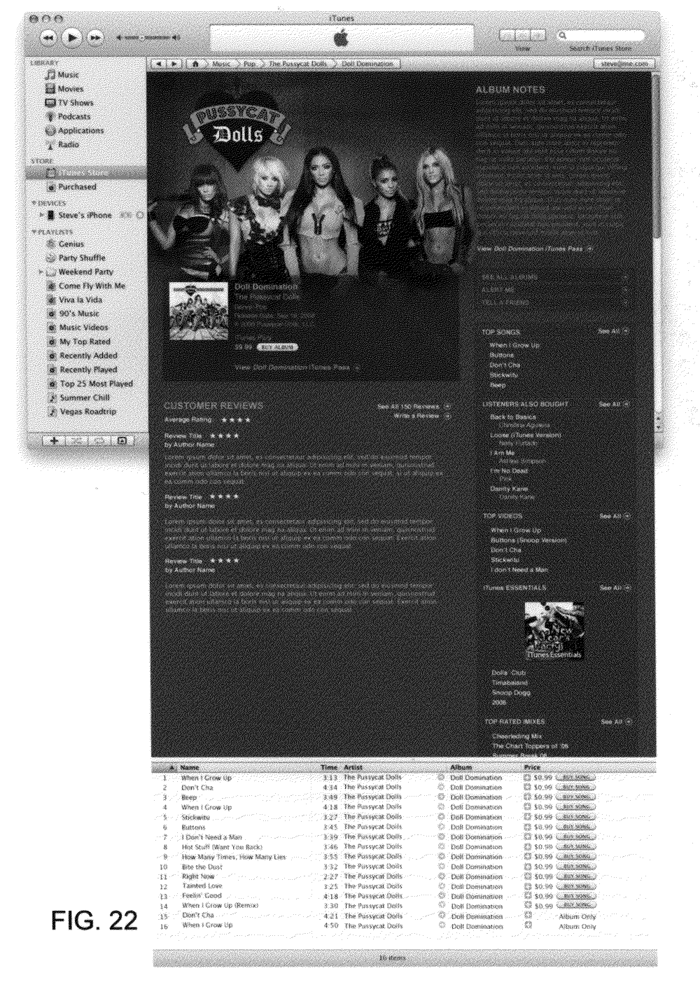

FIG. 22 is a screenshot of an album page having a link to a media pass page according to one embodiment of the invention. In this album page, it is assumed that the media pass is associated with the album. As an example, in the media assets within the album are used as part of the media assets to be included within the media pass. Thus, the link from the album to the media pass can automatically be produced and provided with the album page.

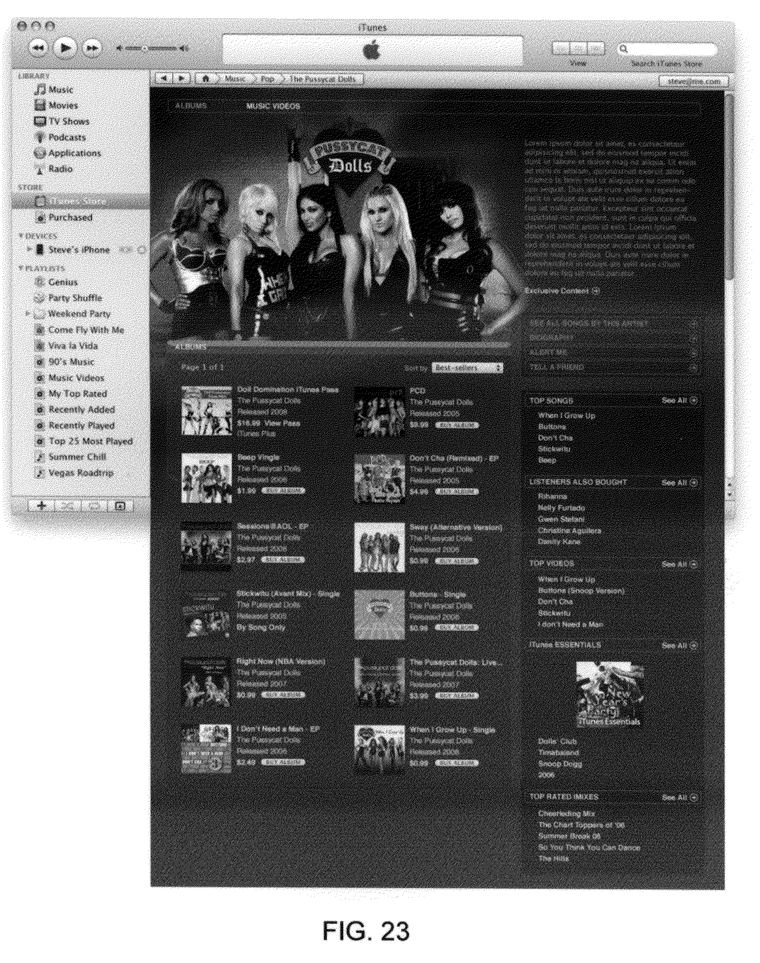

FIG. 23 is a screenshot of an artist page having a link to a media pass page according to one embodiment of the invention. In this artist page, it is assumed that the media pass is associated with an artist of the artist page. The link to the media pass can be presented in a similar manner as it is for an album. For example, the link to the media pass can be affiliated with an image (e.g., cover art) link or a text link. Selection on the link causes navigation to the media pass page.

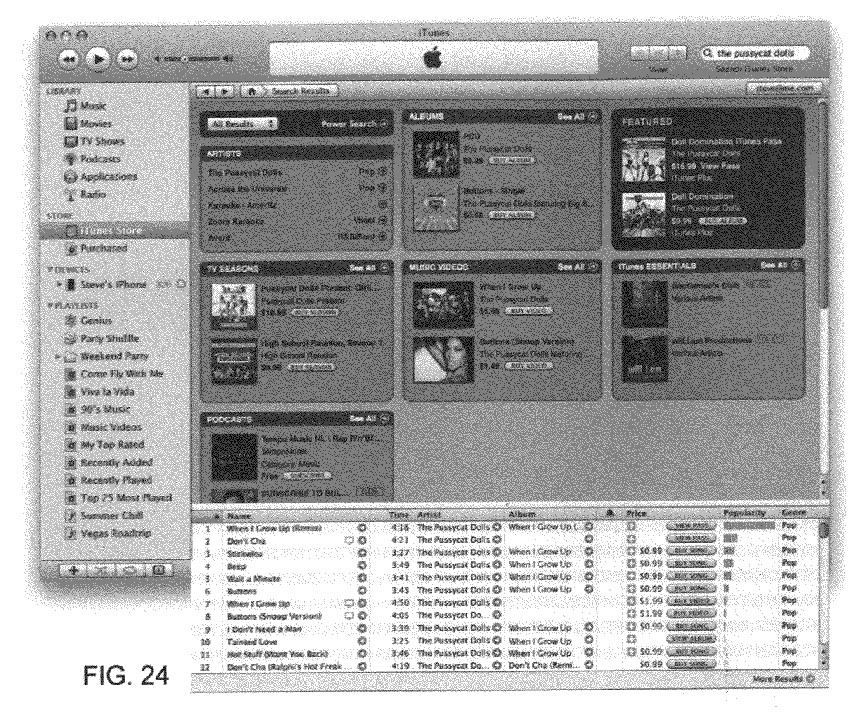

FIG. 24 is a screenshot of a search results page according to one embodiment of the invention. The search results page can include meaty passes similar to the manner in which it includes albums. Hence, in one example, those media passes that satisfy the search criteria, can be displayed together with a link “View Pass” that allows a user to navigate to the corresponding media pass page.

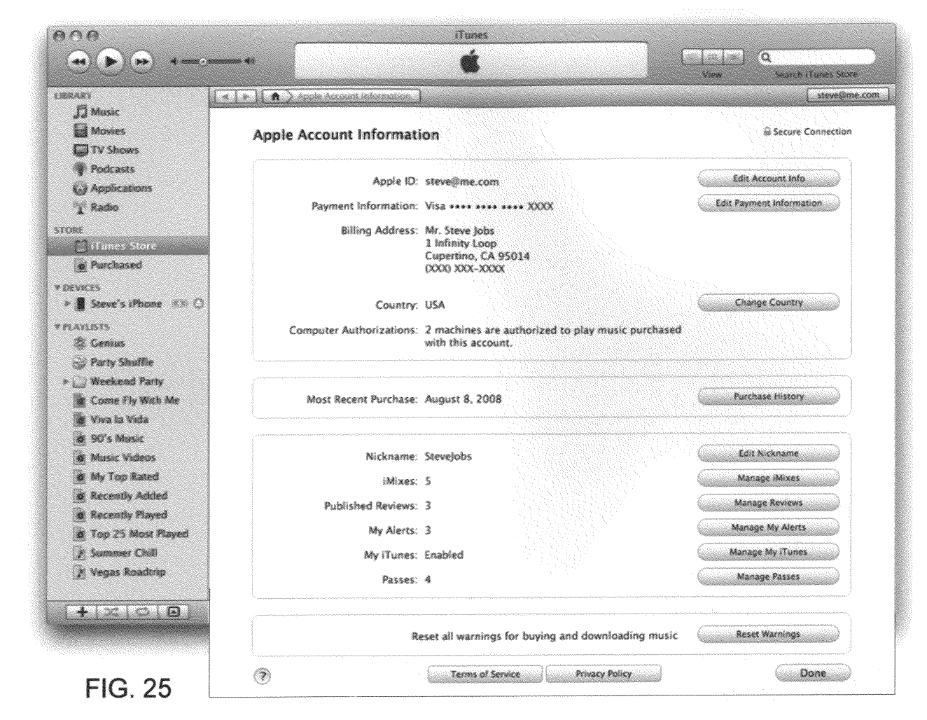

FIG. 25 is a screenshot of an account page according to one embodiment of the invention. The account page can permit the user to manage the one or more media passes associated with the user. For example, the media passes associated with the user can be those one or more media passes that have been purchased by the user.

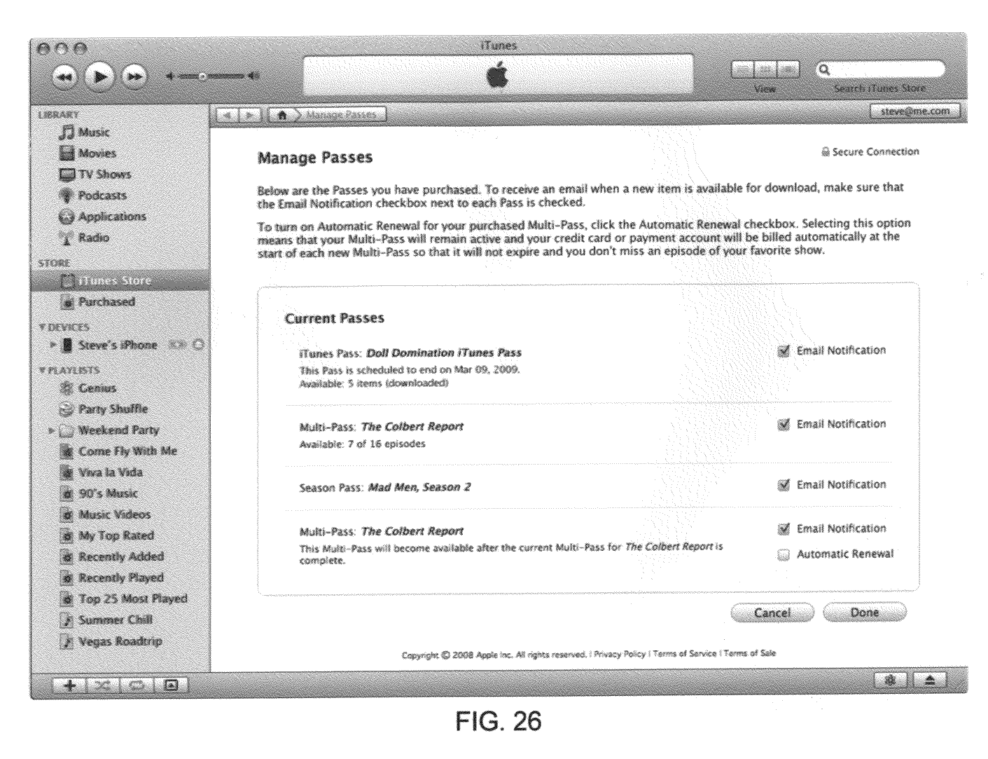

FIG. 26 is a screenshot of a manage passes page according to one embodiment of the invention. The manage passes page can facilitate management of current media passes. For example, a user can opt-in or opt-out of all of receiving e-mail notifications pertaining to the media passes.

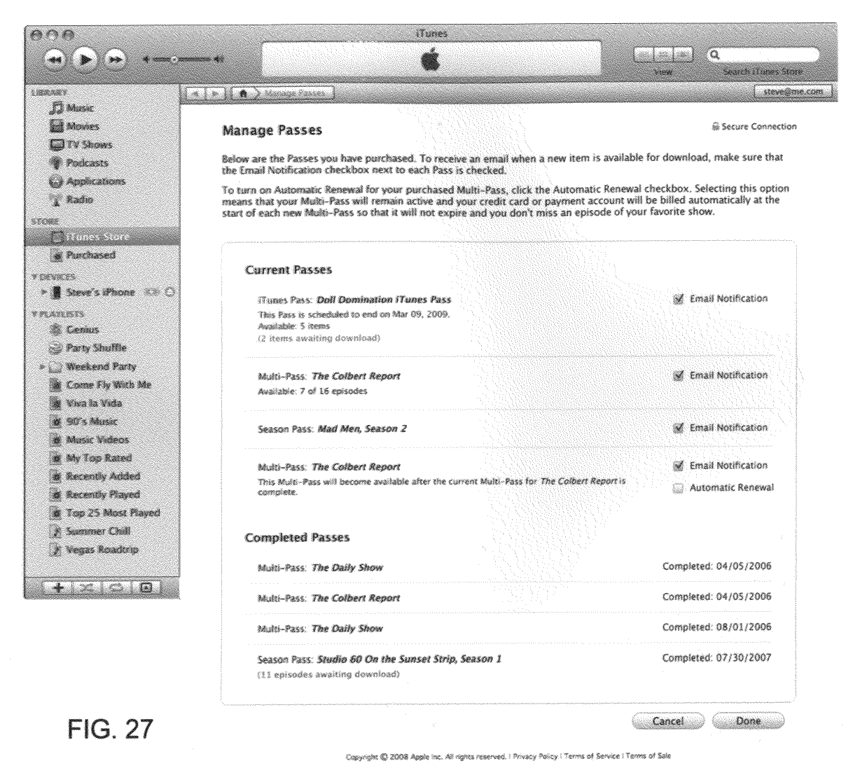

FIG. 27 is a screenshot of a manage passes page according to one embodiment of the invention. The manage passes page as described in this screenshot also facilitates management of current media passes that have one or more downloads associated with the media passes that are available to the user. For example, the manage media passes page can display an indication of the number of downloads available to the user.

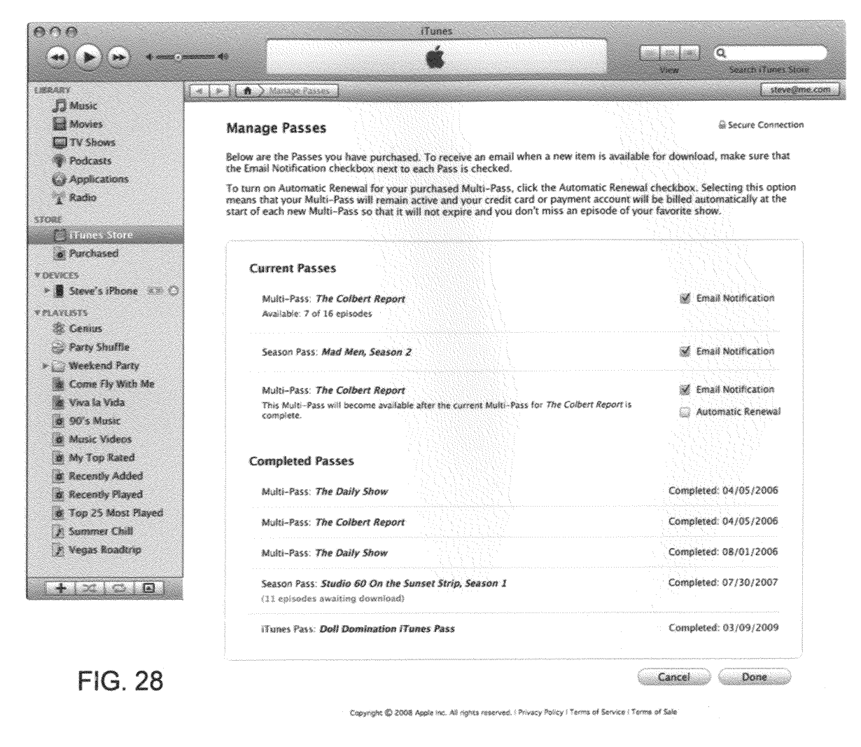

FIG. 28 is a screenshot of a manage passes page according to one embodiment of the invention. The manage passes page as illustrated in this screenshot facilitates management of those media passes that are completed. For example, once a media pass has been completed, the media pass can be moved into the completed passes section of the manage passes page where the media pass can be identified by name and provide an indication of its completed date.

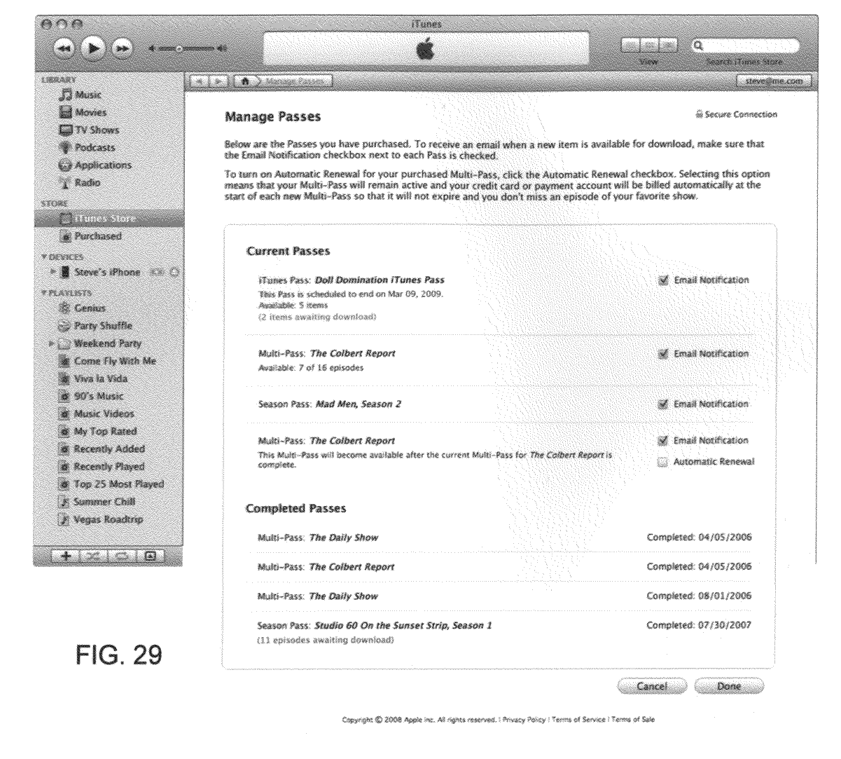

FIG. 29 is a screenshot of a manage passes page according to one embodiment of the invention. The manage passes page as illustrated in this screenshot also facilitates management of those media passes that are completed. For example, once a media pass has been completed but still has available downloads, the media pass can be moved into to be completed passes section of the manage passage page but additional download information will be displayed to inform the user that one more downloads are available.

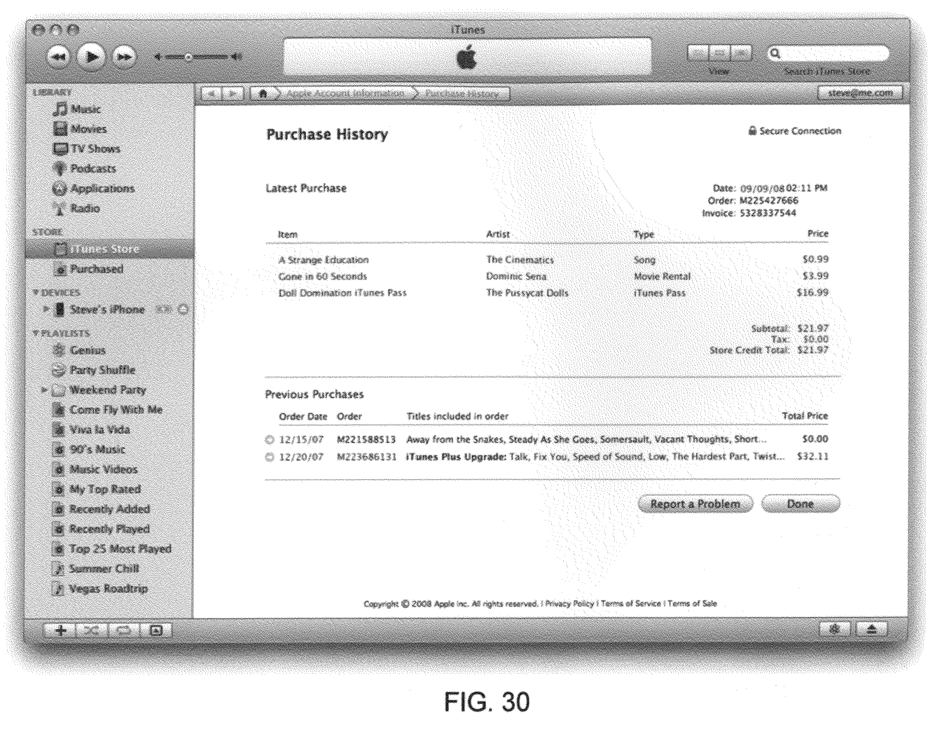

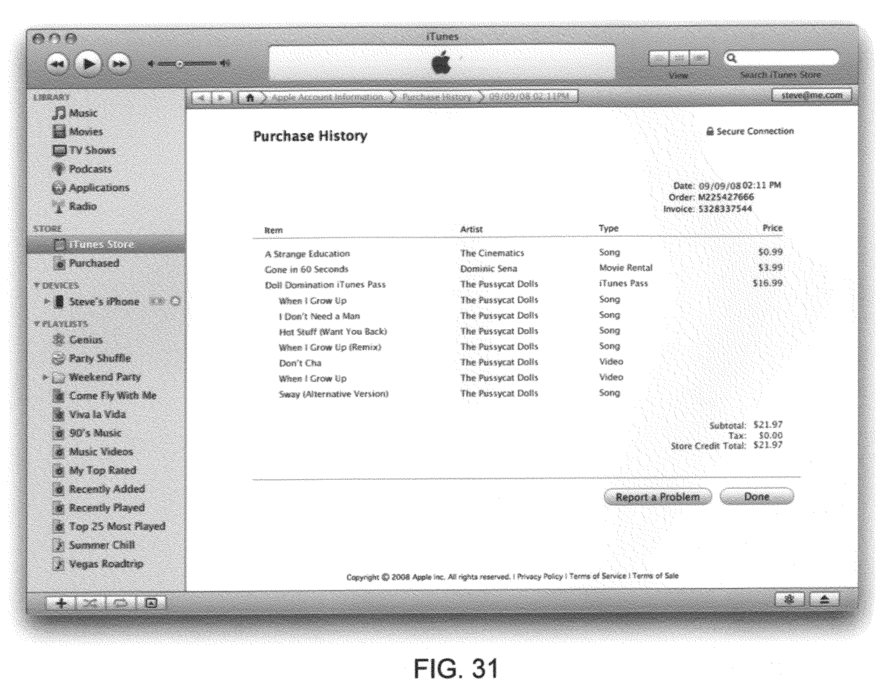

FIG. 30 is a screenshot of a purchase history page according to one embodiment of the invention. The purchase history page can, among other things, indicate to the user what media passes they have previously purchased.

FIG. 31 is a screenshot of a purchase history page according to one embodiment of the invention. Here, the purchase history page can further illustrate those media items of a media pass that have been downloaded.

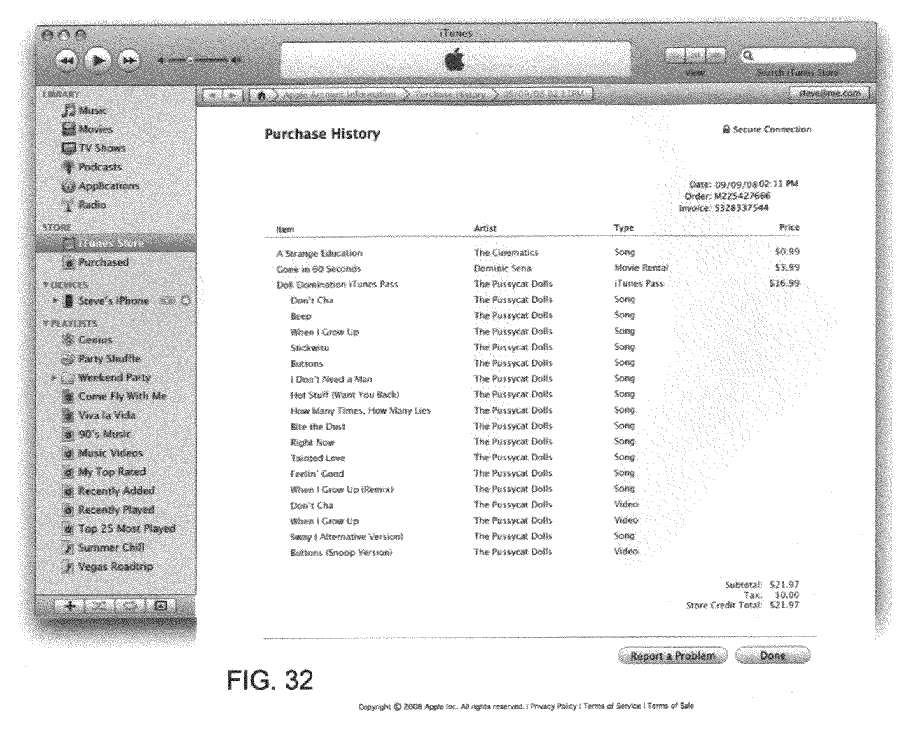

FIG. 32 is a screenshot of a purchase history page according to one embodiment of the invention. In this example, the media pass is completed. As such, the purchase history page illustrates all the associated media items that have been downloaded for the media pass.

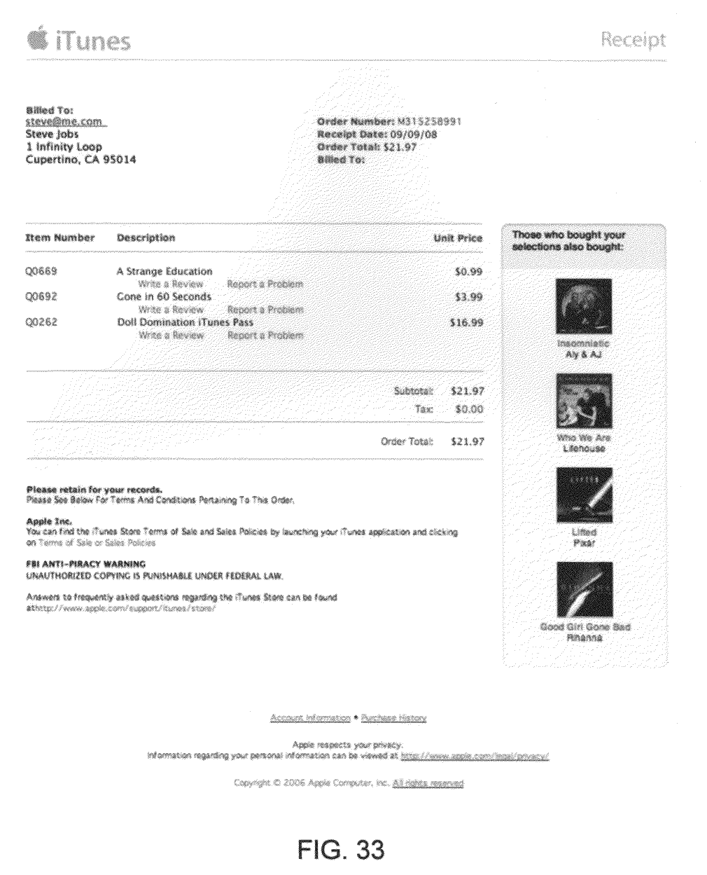

FIG. 33 is a screenshot of an invoice email according to one embodiment of the invention. The invoice email can list those one or more media passes that the user has purchased.

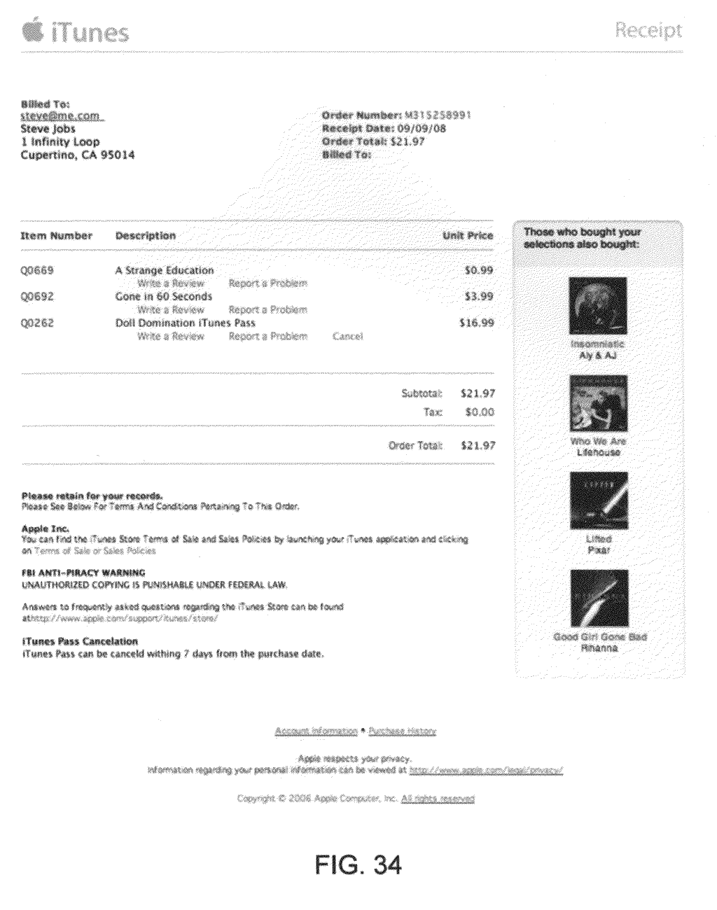

FIG. 34 is a screenshot of an EU version invoice email according to one embodiment of the invention. The EU version invoice email can list those one or more media passes that the user has purchased from an EU storefront. The EU version invoice email can include a cancel link which allow the user to cancel a purchase within a predetermined period of time.

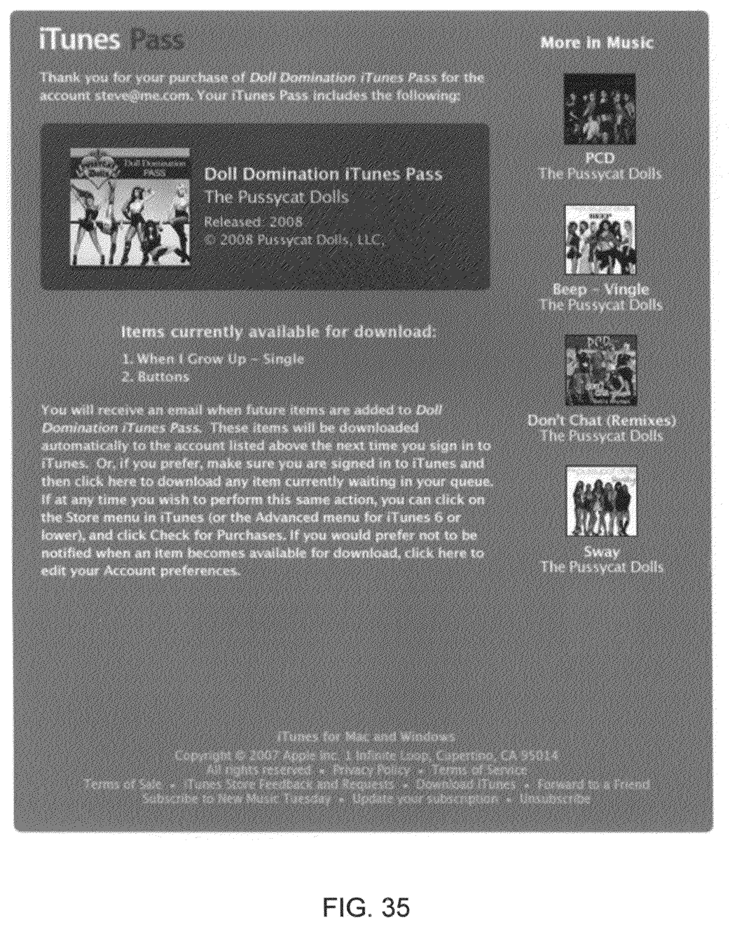

FIG. 35 is a screenshot of a new media pass purchase email according to one embodiment of the invention. The new media pass purchase email can be sent to users who have purchased a media pass. The new media pass purchase email can also indicate to the user those media items of the media pass that are presently available for download.

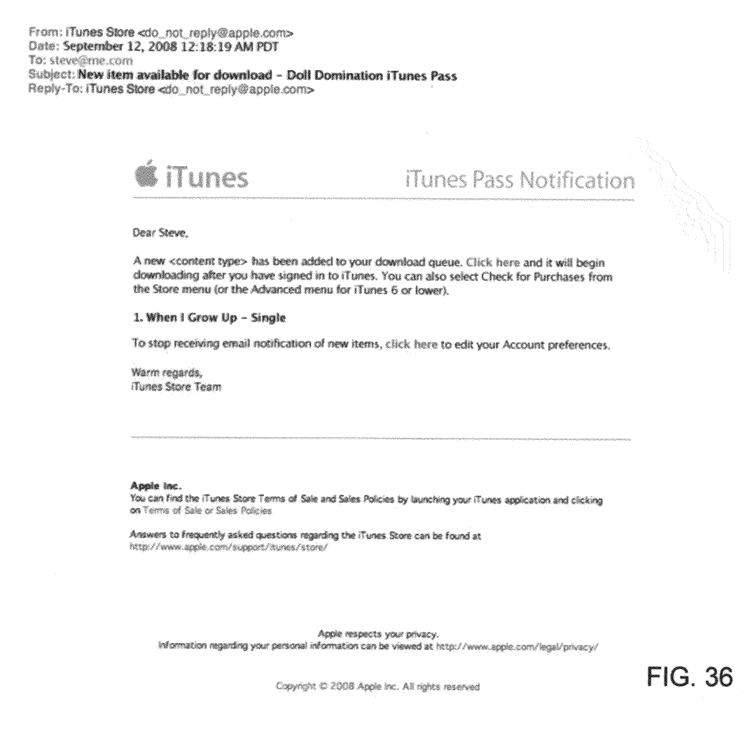

FIG. 36 is a screenshot of a new media item notification email according to one embodiment of the invention. The new email item notification email can be sent to those users that have opted to receive email notifications. The new media item notification email can notify a user of a now available media item of a media pass that the user has previously purchased.

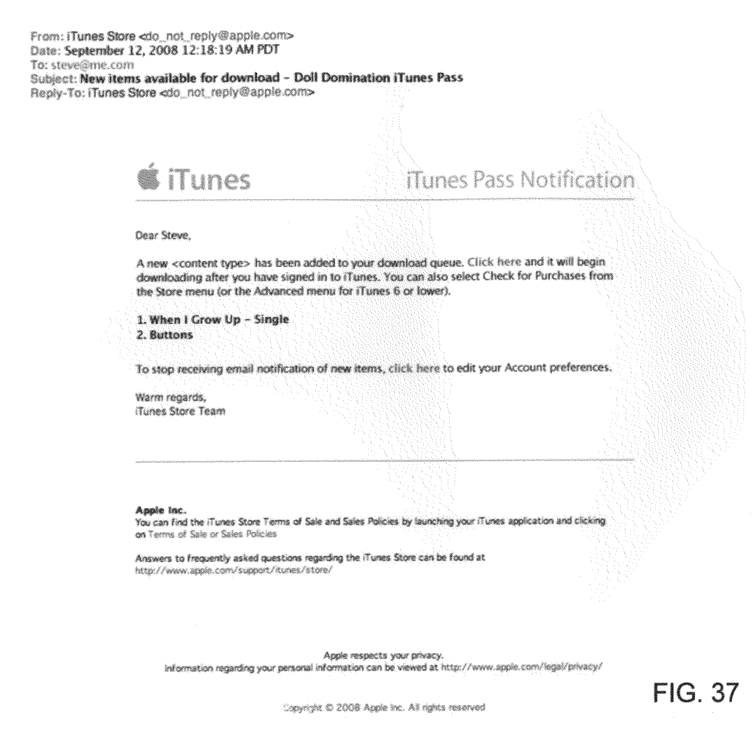

FIG. 37 is a screenshot of a new media item notification email according to another embodiment of the invention. The new email item notification email can be sent to those users that have opted to receive email notifications. The new media item notification email can notify a user of multiple now available media items of a media pass that the user has previously purchased. Typically, the notification email is sent only once per day.

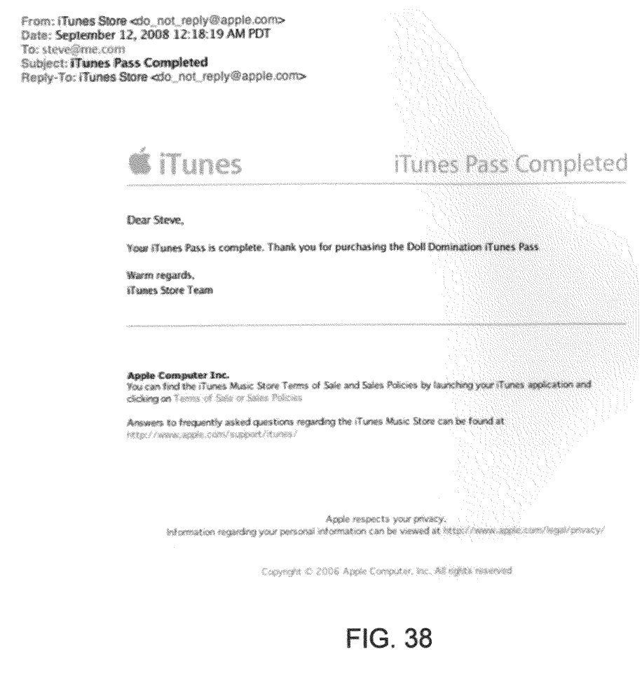

FIG. 38 is a screenshot of a media pass complete notification email according to one embodiment of the invention. The media pass complete notification email can be sent to those users that have opted to receive email notifications. The media pass complete notification email can notify a user that the media pass is now completed.

The digital media assets (i.e., digital media items) can pertain to video items (e.g., video files or movies), audio items (e.g., audio files or audio tracks, such as for songs (music) or audiobooks), or image items (e.g., photos). The digital media assets can also include or be supplemented by text or multimedia files.

The various aspects, features, embodiments or implementations of the invention described above can be used alone or in various combinations.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that set (e.g., season, media pass, etc.) of digital media assets can be supported by an on-line media store. Another advantage of the invention is that a set of digital media assets can be purchased and an initial portion of digital media assets of the set delivered, while a remaining portion of digital media assets of the season can be subsequently delivered when they later become available. Another advantage of the invention is that an entire season of digital media assets can be purchased with a single transaction even though the season has not completed. Another advantage of the invention is that a user can purchase a set of digital media assets that will be made available for a given artist, group, program, label, developer, producer or director. At the time the set of digital media assets is purchased, none, some but not all of the digital media assets will be available. Still another advantage of the invention is that sets (e.g., seasons, media passes, etc.) of digital media assets can be managed via an on-line media store.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for acquiring a set of digital media assets from an on-line media store, said method comprising:
presenting a plurality of sets of related digital media assets that are available for purchase on the on-line media store, for each of the set of related digital media assets available for purchase, at least a portion of the digital media assets to be included therein are unavailable from the on-line media store;
receiving a selection of one of the sets of related digital media assets to be purchased;
initiating purchase of the selected one of the sets of related digital media assets; and
permitting delivery of available ones of the digital media assets of the selected one of the sets of related digital media assets.

2. A method as recited in claim 1, wherein the selected one of the sets of related digital media assets includes a plurality of different types of digital media assets.

3. A method as recited in claim 1, wherein the selected one of the sets of related digital media assets pertains to a particular artist.

4. A method as recited in claim 1, wherein the selected one of the sets of related digital media assets includes at least one song and at least one video pertaining to the particular artist.

5. A method as recited in claim 1, wherein the selected one of the sets of related digital media assets pertains to a set of artists.

6. A method as recited in claim 1, wherein the selected one of the sets of related digital media assets pertains to a particular group, ranking, event or series.

7. A method as recited in claim 1, wherein at the time the purchase is initiated, at least a portion of the digital media assets of the selected one of the sets of related digital media assets are unknown.

8. A method as recited in claim 1,
wherein the digital media assets of the selected one of the sets of related digital media assets are of a plurality of different media types, and
wherein, at the time the purchase is initiated, at least a portion of the digital media assets of the selected one of the sets of related digital media assets are not only unknown in terms of media content but also media type.

9. A method as recited in claim 1, wherein at the time the purchase is initiated, only a portion of the digital media assets within the selected one of the set of related digital media assets are in existence.

10. A method as recited in claim 1, wherein when the set of related digital media assets are available on the on-line media store, the number of digital media assets to be included in the set of related digital media assets is known or estimated.

11. A method as recited in claim 1, wherein the selected one of the sets of related digital media assets is to include a plurality of digital media assets that are subsequently made available to the on-line media store within a predetermined time period.

12. A method as recited in claim 11, wherein the predetermined time period is six (6) months.

13. A method as recited in claim 1,
wherein the delivery is to a client device, and
wherein as one or more other of the digital media assets within the selected one of sets of related series of digital media assets become available, the one or more other of the digital media assets are made available to or provided to the client device.

14. A method as recited in claim 1, wherein the delivery involves downloading to the client device.

15. A method as recited in claim 1, wherein said method further comprises:
subsequently receiving a request to cancel the purchase of a remaining portion of the selected one of the sets of related digital media assets.

16. A method as recited in claim 15,
wherein the purchase of the selected one of the sets of related digital media assets is at a total set cost, and
wherein at the time of cancellation, a partial refund is applied to a user account which is a pro-rata amount of the total set cost.

17. A method as recited in claim 1,
wherein the purchase of the selected one of the sets of related digital media assets is at a total set cost, and
wherein the total set cost is determined dependent on the total number of digital media assets expected in the set of related digital media assets.

18. A method as recited in claim 1,
wherein the purchase of the selected one of the sets of related digital media assets is at a total set cost, and
wherein the total set cost is less than the sum of the individual costs of all the digital media assets, including available and expected, within the selected one of the sets of related digital media assets.

19. A method as recited in claim 1, wherein at least one of the digital media assets of the selected one of the sets of related digital media assets is a bonus item that that is not otherwise available for purchase on the on-line media store.

20. A method as recited in claim 1, wherein said method further comprises:
determining whether one or more other of the digital media assets within the selected one of the sets of related digital media assets have subsequently been made available; and
sending an electronic notification to the client device or its user that the one or more other of the digital media assets within the selected one of the sets of related digital media assets have subsequently been made available.

21. A method for acquiring digital media assets from an online repository, said method comprising:
facilitating browsing of sets of digital media assets available for browsing and purchasing from an online repository, wherein the sets are defined by set characteristics, and wherein the sets of digital media assets are available even though at least one of the digital media assets for each of the sets of digital media assets does not yet exist;
processing purchase of a selected set of digital media assets;
delivering those of the digital media assets of the selected set of digital media assets that are available;
subsequently determining whether one or more newly available digital media assets exist for the selected set of digital media assets;
delivering the one or more newly available digital media assets for the selected set of digital media assets that are determined to exist;
determining whether the set of digital media assets is completed; and
denoting the set of digital media assets as completed if said determining determines that the set of digital media assets is completed.

22. A method as recited in claim 21, wherein the purchase is requested by a purchaser via an electronic device associated with the purchaser, and wherein said delivering is to the electronic associated with the purchaser.

23. A method as recited in claim 22, wherein said method comprises:
notifying the purchaser that the one or more newly available digital media assets exist for the selected set of digital media assets.

24. A computer readable medium including at least executable computer program code stored therein for acquiring a set of digital media assets from an on-line media store, said computer readable medium comprising:
computer program code for presenting a plurality of media sets that are available for purchase on the on-line media store;
computer program code for receiving a selection of one of the media sets to be purchased;
computer program code for initiating purchase of the selected media set; and
computer program code for permitting delivery of available ones of the digital media assets of the selected media set.

25. A computer readable medium as recited in claim 24, wherein each of the media sets is to include a plurality of digital media assets, with a plurality of the media sets including digital media assets of a plurality of different media types.

26. A computer readable medium as recited in claim 25,
wherein at least one of the digital media assets to be included in the selected media set is still unavailable when the purchase of the selected media set is initiated, and
wherein said computer readable medium further comprises:
computer program code for subsequently permitting delivery of the at least one digital media asset that was unavailable when the purchase of the selected media set was initiated once the at least one digital media asset becomes available.

27. A computer readable medium as recited in claim 24, wherein each of the media sets is to include a plurality of digital media assets,
wherein said computer program code for presenting comprises:
computer program code for presenting, for at least one of the selected media sets, a media set description as well as a list of digital media assets that are available and included within the selected media set, wherein the list of digital media assets is incomplete since at least one of the digital media assets to be included in the selected media set is not yet available.

28. A media server, comprising:
at least one data storage device, said data storage device storing (i) media set information for a plurality of sets of digital media assets, with the media set information for each of the sets of digital media assets characterizing a plurality of digital media assets that are included within such set, and (ii) at least a subset of the plurality of digital media assets or pointers thereto; and
a data processing unit operatively connected to said at least one storage device, said data processing unit performing a purchase process to enable users to select one or more of the sets of digital media assets for purchase, said processing unit further performing a fulfillment process to deliver, to the user that has purchased such, a first portion of the plurality of digital media assets that are currently available for the purchased set of digital media assets and one or more remaining portions of the digital media assets as they become available.

29. A media system as recited in claim 28, wherein said media server further comprises:
an import engine for receiving media content and/or the characterizations for the sets of digital media assets from media content providers.
